(19) United States
(12) Patent Application Publication
(10) Pub. No.: US 2009/0095940 A1
(43) Pub. Date: Apr. 16, 2009

(54) High quantum yield infranred phosphors and methods of making phosphors

(76) Inventors: Richard S. Meltzer, Athens, GA (US); Sergey Feofilov, Petersburg (RU); Yi Zhou, Athens, GA (US); Douglas Keszler, Corvallis, OR (US); Joayoung Jeong, Corvallis, OR (US); Weiyi Jia, Chelmsford, MA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/217,582

(22) Filed: Jul. 7, 2008

Related U.S. Application Data
(60) Provisional application No. 60/947,999, filed on Jul. 5, 2007.

(51) Int. Cl. C09K 11/61

(52) U.S. Cl. 252/301.4 H

(57) ABSTRACT

Embodiments of the present disclosure include Gd³⁺—Nd³⁺ infrared phosphor compositions, methods of making Gd³⁺—Nd³⁺ infrared phosphor compositions, and the like.

### CROSS-REFERENCE TO RELATED APPLICATION

This application claims priority to co-pending U.S. provisional application entitled “INFRARED PHOSPHORS AND METHODS OF MAKING” having Ser. No. 60/947,999, filed on Jul. 5, 2007, which is entirely incorporated herein by reference.

### STATEMENT REGARDING FEDERALLY SPONSORED RESEARCH OR DEVELOPMENT

This invention was made with government support under Grant No.'s 0305400 and 0305449 awarded by the National Science Foundation. The U.S. government has certain rights in the invention.

### BACKGROUND

It has been suggested that improvements in fluorescent lamps could be realized by replacing the mercury discharge by xenon, thereby removing the deleterious environmental impact of mercury and, at the same time, improving the energy efficiency. Such innovations require a phosphor that absorbs one vacuum ultraviolet (VUV) photon and emits two or more visible photons, an effect known as quantum splitting or down conversion.

Quantum splitting can occur either through a process of sequential cascade emission as an excited ion returns to its ground state by first radiating to an intermediate state or by some cross relaxation process which enables the initially excited ion to share its excitation energy with two or more ions, each of which emits a visible photon. Both of these processes have been demonstrated. Cascade emission was first demonstrated in YF₃:Pr with a 140% quantum efficiency. Cross relaxation induced quantum splitting has been described for GdLiF₄:Eu with an internal quantum efficiency of 190%.

Unfortunately, neither of these schemes has so far yielded a useful phosphor. For the cascade emission, the first photon occurs at 406 nm, too far in the deep blue where the sensitivity of the human eye is very low. For the cross relaxation scheme in GdLiF₄:Eu, the absorption of the VUV photon is too weak to produce a phosphor with high brightness.

### SUMMARY

Embodiments of the present disclosure include Gd³⁺—Nd³⁺ infrared phosphor compositions comprising GdₓY₁₋ₓLiF₄:Nd, where 0.1≦x≦1, and methods of making phosphors.

Briefly described, embodiments of the present disclosure include a method of making GdₓY₁₋ₓLiF₄:Nd (0.1≦x≦1), among others, comprising: synthesizing Gd₁₋ₓYₓF₃ by heating a mixture of molar equivalents of the following: about 1−x Gd₂O₃, about x Y₂O₃, and about 3 to 8 NH₄F, at about 750 to 950° C. for about 1 to 4 hours; mixing the Gd₁₋ₓYₓF₃ with molar equivalents of the following: about 1 to 1.25 LiF, about 0.005 to 0.05 Nd₂O₃, and about 2 to 5 NH₄F; thoroughly grinding the mixture; and firing the mixture at about 650 to 850° C. for about 1 to 4 hours.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

The patent or application file contains at least one drawing executed in color. Copies of this patent or patent application publication with color drawing(s) will be provided by the Office upon request and payment of the necessary fee.

FIG. 1 is a graph that illustrates relative quantum yield of GdLiF₄:Nd 2% exciting at 160 nm (black, solid curve) and at 351 nm (red, dashed curve). The spectra are normalized on the Nd³⁺⁴D_{3/2} and ²P_{3/2} quantum yields.

FIG. 2 illustrates energy level diagrams of Nd³⁺ and Gd³⁺ in GdLiF₄:Nd with the relevant energy levels labeled. The open box represents the 4f²5d band of Nd³⁺. The boxed areas with horizontal lines represent energy regions with a high density of 4fⁿ levels. ET1 and ET2 indicate resonant energy transfer processes. Labels A, B, and C next to the red (dashed) lines denote three cross relaxation energy transfer processes. Some of the intrinsic lifetimes are indicated.

FIG. 3(A) is a graph that illustrates absorption spectrum of YLiF₄:Nd 2%. FIG. 3(B) is a graph that illustrates emission spectrum of YLiF₄:Gd 5% showing significant spectral overlap.

FIG. 4 is a graph that illustrates excitation spectrum of GdLiF₄ containing 1%, 2% and 3% Nd³⁺ and detecting the Nd³⁺⁴F_{3/2} emission using a cutoff filter that transmits for λ>780 nm. Features of the ⁶G_{J}, ⁶D_{J} and ⁶I_{J} levels of Gd³⁺ and the 4f²5d bands of Nd³⁺ are indicated.

FIG. 5 is a graph that illustrates comparison of the excitation spectra of GdLiF₄:Nd 2% detecting only the ⁴F_{3/2} emission with k_{detect}>780 nm with that of the case of detection for k_{detect}<780

FIG. 6 is a graph that illustrates time evolution of the ⁶I (281 nm) and ⁶P_{7/2} (313 nm) emission intensities of Gd³⁺ and the ⁴D_{3/2} and ⁴F_{3/2} emission intensities of Nd³⁺ in a GdLiF₄:Nd 2% sample under 157 nm pulsed laser excitation.

FIG. 7 is a graph that illustrates time evolution of the ⁶I (281 nm) and ⁶P_{7/2} (313 nm) emission intensities of Gd³⁺ under 157 nm pulsed excitation in GdLiF₄:Nd for 1%, 2%, and 3% Nd concentrations. The dashed lines show the fits using the ⁶I decay times shown in the figure. Those same times are used as the rise times in the fits to the ⁶P_{7/2} emission for the sample with the same Nd³⁺ concentration.

FIG. 8 is a graph that illustrates time evolution of the ⁴D_{3/2} and ²P^{3/2} emission of Nd³⁺ in a sample of GdLiF₄:Nd 2% under 355 nm excitation and the ⁴P_{3/2} emission under 157 nm excitation. The decay of ²P^{3/2} is the rate limiting state in the feeding of ⁴F_{3/2}. Also plotted as dashed lines are fits to the data using the rise and decay times indicated on the figure.

FIG. 9 is a graph that illustrates time evolution of the ²P^{3/2} and ⁴F_{3/2} emission in a GdLiF₄:Nd 2% sample under 355 nm and 157 nm excitation. The fits shown on the figure are obtained using the rise and decay times indicated in the legend. The percentage indicates the fraction of population buildup, which is contributed by this rise time. The remainder of the population buildup is taken to appear immediately after excitation.

FIG. 10(A) is a graph that illustrates excitation spectra of YLiF₄:Gd³⁺ (detecting Gd³⁺ emission), GdLiF₄:Eu³⁺ (detecting Eu³⁺ emission). FIG. 10(B) is a graph that illustrates emission spectrum of Gd_{0.1}Y_{0.9}LiF₄:Nd 2% showing overlap of Nd³⁺ emission with the Gd³⁺ absorption (A).

FIG. 11 is a graph that illustrates 4f5d emission spectrum of Nd³⁺ in GdₓY₁₋ₓLiF₄:Nd 2% as a function of Gd³⁺ concentration x. The insert shows the probability p=C₄ⁿxⁿ(1−x)⁴⁻ⁿ of a Gd³⁺ having n=0 through n=4 of its nearest neighbor cation sites occupied by another Gd³⁺.

FIG. 12 is a graph that illustrates emission spectra excited at 160 nm of three GdₓY₁₋ₓLiF₄:Nd 2% samples for x=0.1, 0.25, and 0.5.

FIG. 13 is a graph that illustrates time-resolved emission at 313 nm from the ⁶P_{7/2} state of Gd³⁺ in several GdₓY₁₋ₓLiF₄:Nd 2% samples with x between 0.1 and 1. The data is plotted as a log-log plot to allow display of many decades of time and intensity.

FIG. 14 is a graph that illustrates time-resolved emission of three GdₓY₁₋ₓLiF₄:Nd 2% samples as a function of x. Decays of Gd³⁺ from both ⁶I (280 nm) and ⁶P_{7/2} (313 nm) are shown by the data points along with fits (solid and broken lines) to the data with the exponential decay and rise times indicated next to each curve.

FIG. 15 is a graph that illustrates emission of GdLiF₄ doped with thulium showing the presence of IR emission near 800 nm under vacuum UV excitation.

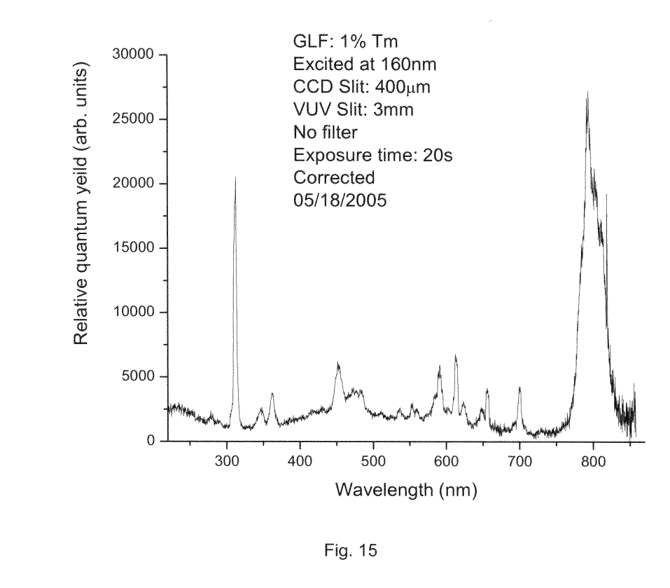

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of physics, chemistry, and the like, which are within the skill of the art. Such techniques are explained fully in the literature.

The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,”“an,” and “the” include plural referents unless the context clearly dictates otherwise. Thus, for example, reference to “a compound” includes a plurality of compounds. In this specification and in the claims that follow, reference will be made to a number of terms that shall be defined to have the following meanings unless a contrary intention is apparent.

### DISCUSSION

Embodiments of the present disclosure include Gd³⁺—Nd³⁺ infrared phosphor compositions, methods of making Gd³⁺—Nd³⁺ phosphor compositions, and the like. In general, embodiments of the Gd³⁺—Nd³⁺ infrared phosphor composition can include, but are not limited to, GdₓY₁₋ₓLiF₄:Nd, where 0.1≦x<1. In an embodiment, 0.1<x<1.

Embodiments of the present disclosure include GdₓY₁₋ₓLiF₄:Nd, where Nd³⁺ is about 0.5 to 3.0 mol % of the composition. In an embodiment, Nd³⁺ is about 1 to 3 mol %. In another embodiment, Nd³⁺ is replaced by Tm³⁺ (e.g., GdₓY₁₋ₓLiF₄:Tm).

Embodiments of the present disclosure also include a Gd³⁺—Nd³⁺ infrared phosphor composition comprising GdₓY₁₋ₓLiF₄:Nd, where Nd³⁺ is about 2 mol % of the composition.

Embodiments of the present disclosure also include a Gd³⁺—Nd³⁺ infrared phosphor composition comprising GdₓY₁₋ₓLiF₄:Nd, where x is about 0.5. In an embodiment, x is about 0.25. In another embodiment, x is about 0.1.

Embodiments of the present disclosure include Gd³⁺—Nd³⁺ high quantum yield infrared phosphor compositions. In an embodiment, the Gd³⁺—Nd³⁺ infrared phosphor composition exhibits measured quantum yields of about 0.70 to 1.40, but higher quantum yields are possible. Embodiments of the infrared phosphor can be excited under vacuum via UV excitation.

Embodiments of the infrared phosphor composition could be used in displays or tags, which could be excited and detected with electromagnetic radiation invisible to the eye. Embodiments of the infrared phosphor composition could also be used for a mercury-free IR lamp.

As noted above, embodiments of the present disclosure include Gd³⁺—Nd³⁺ infrared phosphor compositions comprising GdₓY₁₋ₓLiF₄:Nd, methods of making Gd³⁺—Nd³⁺ infrared phosphor compositions, and the like. Although not intending to be bound by theory, the addition of yttrium to the to the phosphor composition may allow for better quantum yields in limited concentrations by also adjusting the Nd³⁺ concentration; may be used to control energy transfer rates between Gd³⁺ and Nd³⁺; and may slow down resonant energy transfer among the Gd ions, thereby reducing losses due to trapping defects.

Embodiments of the present disclosure include a method of making GdₓY₁₋ₓLiF₄:Nd (0.1≦x<1) comprising: synthesizing Gd₁₋ₓYₓF₃ by heating a mixture of molar equivalents of the following: about 1−x Gd₂O₃, about x Y₂O₃, and about 3 to 8 NH₄F at about 750 to 950° C. for about 1 to 4 hours; mixing the Gd₁₋ₓYₓF₃ with molar equivalents of the following: about 1 to 1.25 LiF, about 0.005 to 0.05 Nd₂O₃, and about 2 to 5 NH₄F; thoroughly grinding the mixture; and firing the mixture at about 650 to 850° C. for about 1 to 4 hours. In an embodiment, the mixture is ground in a Pt crucible. The Pt crucible is covered and positioned inside an alumina crucible filled with activated carbon and NH₄F to limit the exposure of the sample to air. Gd₂O₃, NH₄F, LiF, and Nd₂O₃ are each 99.99% and can be purchased from Alfa Aesar.

In an embodiment, the method of making GdₓY₁₋ₓLiF₄:Nd (0.1≦x<1) further comprises: synthesizing Gd₁₋ₓYₓF₃ by heating a mixture in molar equivalents of the following: about 0.1 to 1 Gd₂O₃, about >0 to 0.9 Y₂O₃, and about 3 to 8 NH₄F at about 750 to 950° C. for about 1 to 4 hours. In another embodiment, the method of making GdₓY₁₋ₓLiF₄:Nd (0.1≦x<1) further comprises: synthesizing Gd₁₋ₓYₓF₃ by heating a mixture in molar equivalents of the following: about 0.1 to 1 Gd₂O₃, about 0 to 0.9 Y₂O₃, and about 3 to 8 NH₄F at about 750 to 950° C. for about 1 to 4 hours.

In an embodiment, the method of making GdₓY₁₋ₓLiF₄:Nd (0.1≦x<1) further comprises: synthesizing Gd₁₋ₓYₓF₃ by heating molar equivalents of the following: about 1−x Gd₂O₃, about x Y₂O₃, and about 8 NH₄F at about 900° C. for about 1.5 h.

In an embodiment, the method of making GdₓY₁₋ₓLiF₄:Nd (0.1≦x<1) further comprises: mixing the Gd₁₋ₓYₓF₃ with molar equivalents of the following: about 1.15 LiF, about 0.01 to 0.03 Nd₂O₃, and about 4 NH₄F.

In another embodiment, the method of making GdₓY₁₋ₓLiF₄:Nd (0.1≦x<1) further comprises: firing the mixture at about 750° C. for about 1.5 h. In an embodiment, the firing can be performed in a Pt crucible. The Pt crucible is covered and positioned inside an alumina crucible filled with activated carbon and NH₄F to limit the exposure of the sample to air.

Embodiments of the present disclosure include a method of making GdₓY₁₋ₓLiF₄:Nd (0.1<x<1) comprising: synthesizing Gd₁₋ₓYₓF₃ by heating molar equivalents of the following: about 1−x Gd₂O₃, about x Y₂O₃, and about 3 to 8 NH₄F at about 750 to 950° C. for about 1 to 4 hours; mixing the Gd₁₋ₓYₓF₃ with molar equivalents of the following: about 1 to 1.25 LiF, about 0.005 to 0.05 Nd₂O₃, and about 2 to 5 NH₄F; thoroughly grinding the mixture; and firing the mixture at about 650 to 850° C. for about 1 to 4 hours. In an embodiment, the firing can be performed in a Pt crucible. The Pt crucible is covered and positioned inside an alumina crucible filled with activated carbon and NH₄F to limit the exposure of the sample to air.

In regard to embodiments of the present disclosure, quantum splitting due to cross relaxation between Gd³⁺ and Nd³⁺ was studied in mixed crystals of GdₓY₁₋ₓLiF₄ containing 1% Nd³⁺. As x increases, under excitation at about 160 nm to the strongly absorbing 4f²5d state of Nd³⁺, the direct emission from the 4f²5d state of Nd³⁺ is reduced such that its intensity is in approximate proportion to the fraction of Nd³⁺ ions that have no Gd³⁺ ions in any of the four nearest neighbor positions. For x is about ≧0.75, no 4f²5d emission is observed. In addition, Gd³⁺⁶P_{7/2} emission is observed for all x is about ≧0.1 indicating that rapid energy transfer from Nd³⁺ to Gd³⁺ occurs for at least some of the Nd³⁺ ions. The emission spectrum shows an increase in the relative intensity of the ⁴F_{3/2} emission as x increases, providing evidence for the presence of quantum splitting. The dynamics of the ⁶P_{7/2} emission from Gd³⁺ can be understood by considering two different types of nearest neighbor arrangements. Gd³⁺ ions with no Nd³⁺ ions in any of the four nearest neighbor positions, and those which do have a nearest neighbor Nd³⁺ ion. Those Gd³⁺ ions that are members of closely coupled pairs receive energy from the initially excited Nd³⁺ ions with which they then undergo cross relaxation energy transfer leaving both Nd³⁺ and Gd³⁺ ions in their excited states. The excited Nd³⁺ then emits a photon, returning to its ground state whereupon the excited Gd³⁺ can transfer energy back to Nd³⁺ which emits a second photon.

The very large difference in the CRET rates between the closely coupled ions and ions that are a part of more distant pairs suggests that the exchange interaction is the dominant mechanism for the CRET process, and that this completely dominates the CRET of the concentrated x is about 1 GdLiF₄:Nd samples. The dipole-dipole energy transfer mechanism would not be capable of explaining such a strong distinction in the rates. The fact that the dynamics of the Gd³⁺ ions, which are members of closely coupled pairs with Nd³⁺, are faster for the samples with lower Gd³⁺ concentrations suggests that energy migration among the Gd³⁺ ions plays an important role in the dynamics. In the systems with x is about 0.1 and about 0.25, after the initial transfer from Nd³⁺ to Gd³⁺, the energy remains localized on the pair, whereas in the more concentrated samples, the energy migrates rapidly among the Gd³⁺ ions, spending only a fraction of the time on a Gd³⁺ ion which is a nearest neighbor to Nd³⁺.

### EXAMPLES

### Example 1

Efficient quantum splitting and sensitization of Gd³⁺ is demonstrated for the Gd³⁺—Nd³⁺ system in GdLiF₄:Nd 2%. The quantum splitting results from a two step cross relaxation energy transfer between Gd³⁺ and Nd³⁺ which first involves a transition ⁶G→⁶I on Gd³⁺ and an excitation within the 4f³ configuration of Nd³⁺ followed by a second cross relaxation energy transfer which brings Gd³⁺ to ⁶P_{7/2}. The excited Nd³⁺ ion rapidly relaxes, non-radiatively, to the emitting ⁴F_{3/2} state. The excited Gd³⁺ ion then transfers its energy back to Nd³⁺ which gives rise to the second photon. The process is studied by emission and excitation spectroscopy. The result is a quantum yield for the emission of IR photons which has its maximum of about 1±0.5, at 175 nm. The dynamics of both the Gd³⁺ and Nd³⁺ excited states are studied in detail, providing information about the mechanisms and rates for the various energy transfer processes. It appears that the second step in the quantum splitting is less efficient than the first. It is found that energy migration among the Gd³⁺ ions plays an important role in the quantum splitting and that there is strong evidence that the exchange interaction is the dominant mechanism in the energy transfer. This system provides excellent insights into the quantum splitting process, especially with regard to an evaluation of the details of the dynamics.

### Introduction

We attempted to sensitize the absorption by adding Nd³⁺ to GdLiF₄: Eu³⁺. We found that Nd³⁺ does effectively sensitize the excitation of Gd³⁺. However, in addition, Nd³⁺ undergoes its own very strong cross relaxation with the Gd³⁺ system producing efficient quantum splitting. A similar effect (P. S. Peijzel, W. J. M. Schrama, A. Meijerink, Molec. Phys. S 102, 1285 (2004), which is incorporated by reference for the corresponding discussion) has recently been reported for GdLiF₄:Tm³⁺. In this example we study, in detail, the quantum splitting process for the singly-doped system, GdLiF₄:Nd. The result of exciting Nd³⁺ into the 4f²5d state in the VUV is the appearance of two infrared photons. While this material will not be a commercially viable quantum splitting phosphor since the photons are in the infrared and because of the large energy loss even if two photons were produced per input photon, it does provide important insights into the dynamics and mechanisms of the quantum splitting process. In this example, we (1) demonstrate the existence of the quantum splitting, (2) obtain the actual quantum efficiency of the system relative to the number of input VUV photons, (3) measure and analyze the dynamics of the processes using time-resolved emission, and (4) discuss the mechanisms for the energy transfer.

### Experiment

Samples of GdLiF₄:Nd containing 1, 2, and 3 mol % Nd were prepared in powder form. GdF₃ was first synthesized by heating a mixture of 1 Gd₂O₃ (99.99%, Alfa Aesar) and 8 NH₄F (99.99%, Alfa Aesar) at 900° C. for 1.5 h. The resulting product was then mixed with 1.15 LiF (99.99%, Alfa Aesar), 0.01, 0.02 or 0.03 Nd₂O₃ (99.99%, Alfa Aesar), and 4 NH₄F (99.99%, Alfa Aesar) and thoroughly ground. The mixture was then fired at 750° C. for 1.5 h in a Pt crucible; the Pt crucible was covered and positioned inside an alumina crucible filled with activated carbon and NH₄F to limit the exposure of the sample to air.

All spectra were obtained at room temperature. Emission spectra were obtained by exciting the sample, contained in vacuum, with a deuterium lamp spectrally filtered with an Acton Model VM-502 VUV monochromator containing a concave grating so that selective excitation could be performed. The visible and UV emission was dispersed with an Acton Spectrapro-150 spectrometer and was detected with a Santa Barbara Instrument Group Model ST-6I CCD camera at the exit focal plane. Emission spectra in the VUV were obtained by exciting the sample with a GAM Laser, Model EX5, pulsed molecular F₂ laser whose output is at 157 nm. The sample emission was focused onto the entrance slit of the VUV monochromator. The emission was detected with a solar blind PMT with a MgF₂ window located at a third slit of the VUV monochromator which was scanned to obtain the spectrum. All emission spectra were corrected for the wavelength dependent response of the detection system. For cw excitation in the UV, a UV-enhanced Ar⁺ laser was used at 351 nm.

Excitation spectra were obtained by scanning the VUV monochromator, illuminated by the deuterium lamp, while detecting the emission with a PMT after passing the luminescence through appropriate colored glass or interference filters to select the desired components of the emission. Two PMT detectors were used, both having quartz windows yielding a response in the UV down to 200 nm. One (Hamamatsu R943) had a GaAs photocathode so that emission up to 900 nm could be measured. The other had a photocathode with an S-20 response. The excitation spectra of each sample were compared to that of a reference sample of sodium salicylate whose quantum efficiency is assumed to be about 58% and constant over the excitation wavelength range from 140 to 320 nm (J. K. Berkowitz, J. A. Olsen, J. Lumin. 50, 111 (1991), which is incorporated by reference for the corresponding discussion). The measured quantum yield is relative to input photons rather than absorbed photons since we have not obtained any reflectance measurements for either the samples or the reference. This assumes similar reflectivities of the sample and the sodium salicylate reference.

For the time-resolved data, the sample was excited with the pulsed laser at 157 nm (10 ns pulse width), while the emission was detected with the same PMTs described above for the excitation spectra. Temporal resolution was about 20 ns. The emission was selected with a 0.25 m monochromator and additional colored glass or interference filters to block light at other wavelengths from entering the monochromator. The bandwidth of the instrument was ˜3 nm. The main limitations of the time-resolved spectra were extraneous signals at early times coming either from broadband red/NIR emission from atomic fluorine in the laser discharge or from fast decay of defect centers that were excited by the VUV excitation. This red/NIR emission was so strong that it was very difficult to do any time resolved spectroscopy from about 620 to 750 nm. For direct excitation of the 4f³ states of Nd³⁺ the third harmonic of a pulsed Nd:YAG laser at 355 nm (10 ns pulse width) was utilized.

### Demonstration of Quantum Splitting

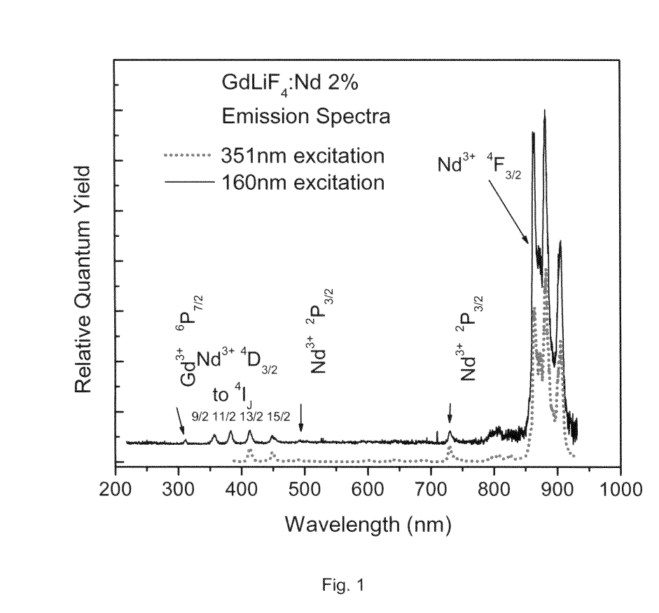

In FIG. 1 the emission spectrum is presented for two different excitation wavelengths, 351 and 160 nm. The emission from 200 nm to 950 nm is dominated by the ⁴F_{3/2}→⁴I_{9/2} transition. However, emission from the ⁴D_{3/2} and ²P^{3/2} states of Nd³⁺ is also observed. Weak emission from the ⁶P_{7/2} state of Gd³⁺ is observed at 313 nm. While it is not evident in this time-averaged spectrum, emission occurs at 281 nm from the ⁶I state of Gd³⁺. Emission from the 4f²5d state of Nd³⁺ in the wavelength range of 180 nm to 270 nm, which dominates the spectrum of YLiF₄:Nd (P. W. Dooley, J. Thogersen, J. D. Gill, H. K. Haugen, R. L. Brooks, Opt. Commun. B183B, 451 (2000), which is incorporated by reference for the corresponding discussion), is not observed in GdLiF₄:Nd, suggesting efficient energy transfer from Nd³⁺ to Gd³⁺, i.e., strong sensitization.

When the spectra excited at the two different wavelengths are compared, by normalizing them to the ⁴D_{3/2} and ²P^{3/2} emission, it is seen that under 160 nm excitation, the relative intensity of the ⁴F_{3/2} emission is more than double that observed for 351 nm excitation. This suggests a process which enhances the excitation of ⁴F_{3/2} in a manner which was used to identify quantum splitting for GdLiF₄:Eu (R. T. Wegh, H. Donker, K. D. Oskam, A. Meijerink, J. Lumin 82, 93 (1999), which is incorporated by reference for the corresponding discussion). This is just the cross relaxation process responsible for quantum splitting.

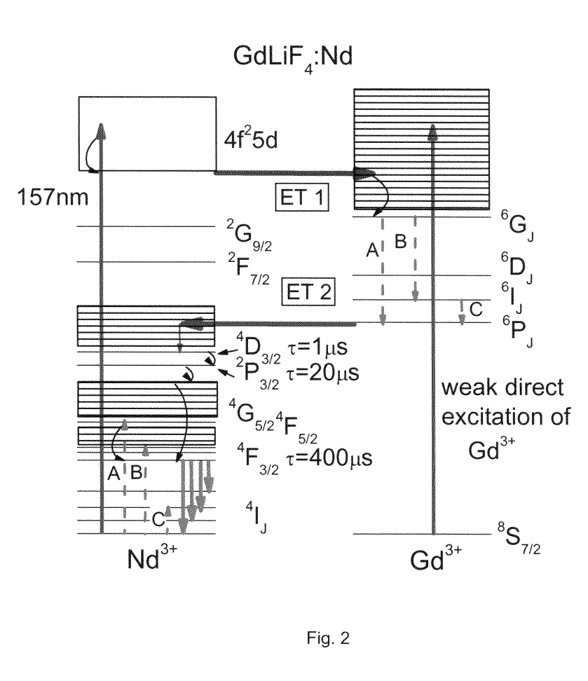

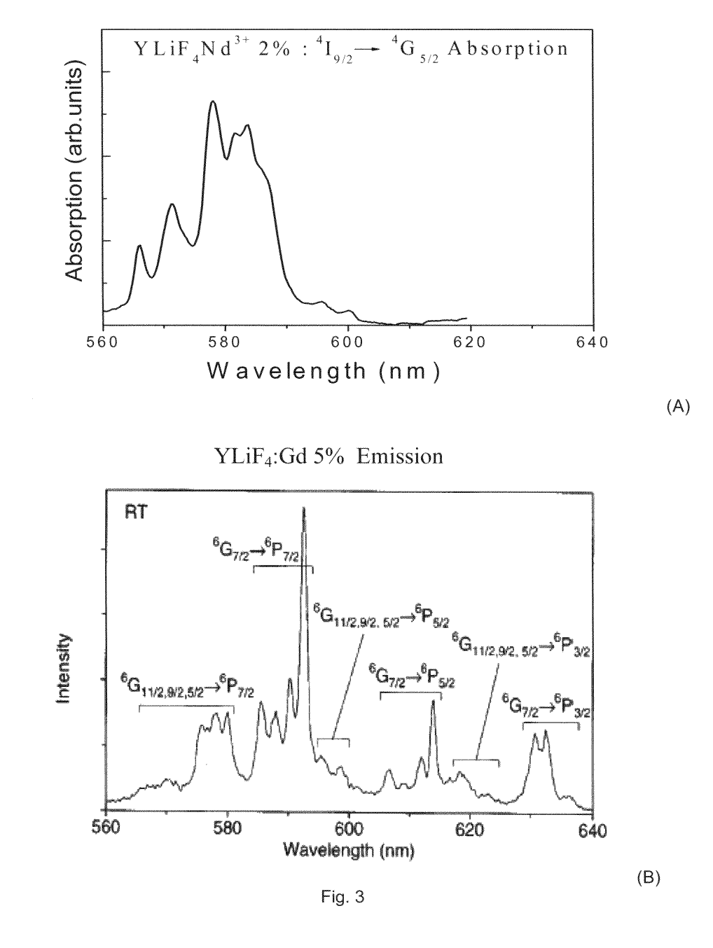

The processes are illustrated in FIG. 2. The diagram shows the relevant 4f³ and 4f⁷ energy levels of Nd³⁺ and Gd³⁺, respectively. Boxed regions with horizontal lines indicate a high density of states of the two 4fⁿ configurations for which rapid multiphonon relaxation occurs. The open box represents the 4f²5d band of Nd³⁺. The 4f⁶5d band of Gd³⁺ is off the energy scale and is not relevant here. The long vertical arrow represents the VUV excitation of Nd³⁺ into the 4f²5d band. Rapid energy transfer to a nearly resonant 4f⁷ state of Gd³⁺, labeled by ET 1, followed by rapid non-radiative relaxation, populates the ⁶G_{J} states of Gd³⁺. Cross relaxation energy transfer from the ⁶G_{7/2} state of Gd³⁺ can occur via two paths. One of these, indicated by the red(dashed) arrows labeled A on the energy level diagrams of Gd³⁺ and Nd³⁺, results in a transition ⁶G_{7/2}→⁶P_{J} on Gd³⁺, as has been previously observed in the Gd—Eu couple, with a simultaneous ⁴I_{9/2}→⁴G_{5/2} excitation on Nd³⁺. These two transitions have considerable overlap as shown in the room temperature spectra of FIG. 3 where the ⁶G_{J}>⁶P_{J} emission of Gd³⁺ observed in YLiF₄:Gd is compared to the ⁴I_{9/2}→⁴G_{5/2} absorption of YLiF₄:Nd. Subsequently, rapid multiphonon relaxation leads to feeding of the ⁴F_{3/2} metastable state from which strong IR emission occurs.

The second pathway involves a transition ⁶G_{7/2}→⁶I_{J} on Gd³⁺ coupled with a ⁴I_{9/2}→⁴F_{5/2}, ²H_{9/2} or ⁴F_{7/2} transition on Nd³⁺ as indicated by the red(dashed) arrows labeled B in FIG. 2. Although the spectra are not available for comparison, the transition energies for Nd³⁺ in absorption (C. Gorller-Walrand, L. Fluyt, P. Porcher, A. A. S. Da Gama, G. F. de Sa, W. T. Carnall, G. L. Goodman, J. Less Common Metals 148, 339 (1989), which is incorporated by reference for the corresponding discussion) and Gd³⁺ predicted for emission (P. S. Peijzel, W. J. M. Schrama, A. Meijerink, Molec. Phys. S 102, 1285 (2004), which is incorporated by reference for the corresponding discussion) are likely to have good resonances. In addition, Peijzel et al. (P. S. Peijzel, W. J. M. Schrama, A. Meijerink, Molec. Phys. S 102, 1285 (2004), which is incorporated by reference for the corresponding discussion) have shown that the reduced matrix elements for this second pathway are about an order of magnitude greater than for the first, making this process about two orders of magnitude faster under the similar resonance conditions. Indeed, as will be shown from studies of the dynamics, the pathway involving the ⁶I_{J} levels does dominate the cross relaxation from ⁶G_{7/2}. However, ⁶I_{J} can further relax to ⁶P_{J} via another cross relaxation process, shown by the red(dashed) arrows labeled C in FIG. 2, that excites the ⁴I_{13/2} state of Nd³⁺. Evidence for this also exists from the dynamical studies discussed below.

The ⁶P_{J} states of Gd³⁺ then transfer their energy to the nearly resonant 4f³ states of Nd³⁺, as shown by the blue(solid) arrow labeled ET 2. Above the ⁴D_{3/2} state of Nd³⁺ there is a very dense, almost continuous forest of energy levels from the 4f³ configuration among which the ²L_{17/2} at ˜32,000 cm⁻¹ is in closest resonance with the ⁶P_{7/2} states of Gd³⁺ (C. Gorller-Walrand, L. Fluyt, P. Porcher, A. A. S. Da Gama, G. F. de Sa, W. T. Carnall, G. L. Goodman, J. Less Common Metals 148, 339 (1989), which is incorporated by reference for the corresponding discussion). Once excited, these will relax almost immediately to the ⁴D_{3/2} level which lives long enough to produce observable emission. Its decay, whose lifetime is about 1 μs, is dominated by non-radiative relaxation to the ²P^{3/2} level which lives much longer with a lifetime of ˜20 μs. These and subsequent multiphonon relaxations ultimately feed the ⁴F_{3/2} level leading to the emission of a second IR photon. On the other hand, when the ⁴D_{3/2} state is excited directly at 351 nm, the cross relaxation step is eliminated so that the relative intensity of ⁴F_{3/2} emission is less than half of that obtained under 157 nm excitation. As described by Wegh et al. (R. T. Wegh, H. Donker, K. D. Oskam, A. Meijerink, J. Lumin 82, 93 (1999), which is incorporated by reference for the corresponding discussion) for GdLiF₄:Eu, this is strong evidence for quantum splitting. The dynamics of the system described below will provide further supporting evidence.

Finally, it should be noted that the assumption that the initial Nd³⁺→Gd³⁺ energy transfer (ET1 in FIG. 2) occurs to Gd³⁺ states resonant with the 4f²5d state of Nd³⁺ may not be a good one. Many possible cross relaxation energy transfer processes are equally possible. These could excite many of the lower-lying states of Gd³⁺ below the energy of the 4f²5d state of Nd³⁺ (˜56,000 cm⁻¹), shown on the Gd³⁺ energy level diagram as the boxed area with many horizontal lines in FIG. 2. For example, cross relaxation processes could leave Nd³⁺ in the ⁴I_{J} levels J= 11/2, 13/2, 15/3 and Gd³⁺ in states above ⁶G_{J} that conserve the total energy. Note that rapid multiphonon relaxation would still lead to a build up in the population of the ⁶G_{J} levels of Gd³⁺ as had been assumed. Cross relaxation processes are also possible in which the energy transfer would result in Gd³⁺ being excited to ⁶D_{J}, ⁶I_{J}, or ⁶P_{J} by leaving Nd³⁺ in its ⁴F_{9/2} (14,800 cm⁻¹), ⁴G_{7/2} (19,000 cm⁻¹), or ⁴G_{11/2} (21,400 cm⁻¹) states, respectively. However, these processes would also still lead to quantum splitting since multiphonon relaxation would populate ⁴F_{3/2} and the excited Gd³⁺ ion would still be capable of transferring its energy to Nd³⁺ for producing the second photon. These processes would supplement the energy transfer processes labeled as A and B that were previously discussed.

### Excitation Spectrum and Quantum Yield

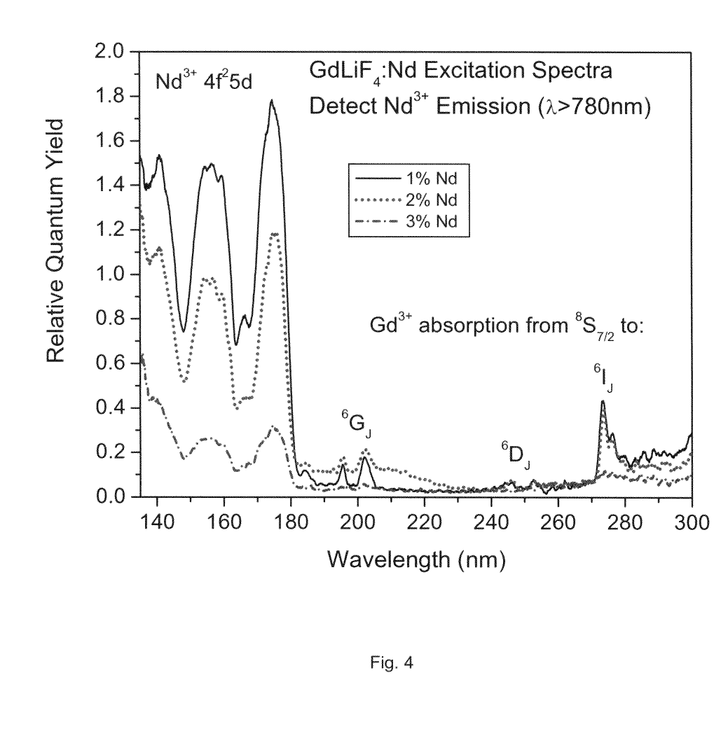

The excitation spectra, detecting the ⁴F_{3/2}→⁴I_{9/2} emission of Nd³⁺ at 780-910 nm, is shown in FIG. 4 for the 1% and 2% and 3% Nd samples. It contains features associated both with Gd³⁺ and Nd³⁺ as indicated on the figure. One clearly sees the states of the 4f⁷ configuration of Gd³⁺, namely ⁶G_{J}, ⁶D_{J} and ⁶I_{J}, indicating that energy transfer between Gd³⁺ and Nd³⁺ occurs, as expected. The 4f²5d bands of Nd³⁺ are also clearly observed.

The quantum yield relative to that of the reference, sodium salicylate, achieves a maximum of 1.8 in the 2% Nd sample for excitation into the 4f→5d bands of Nd³⁺ at 175 nm. This value is obtained by applying a number of corrections to the raw data. First, the raw data are corrected for the fact that the relative quantum efficiency of the PMT for the ⁴F_{3/2}→⁴I_{9/2} emission wavelength of Nd³⁺ between 860 and 910 nm is much less than that at the 380-460 nm emission wavelength range of sodium salicylate. A correction factor for the relative response of the PMT is obtained by convoluting the corrected emission of the sample and sodium salicylate reference, each with the quantum efficiency of the PMT, and calculating the ratio of these products yielding a correction factor of 20±6. A great deal of effort was made to accurately obtain the relative quantum efficiency of the PMT which, because of the rapid decrease in response in the region above 860 nm, leaves this considerable uncertainty of about ±30%. Secondly, it is estimated that only 33% of the ⁴F_{3/2} emitted photons occur on the ⁴F_{3/2}→⁴I_{9/2} transition, based on reported (A. L. Harmer, A. Linz and D. R. Gabbe, J. Phys. Chem. solids, 30, 1483 (1969), which is incorporated by reference for the corresponding discussion) emission spectra of YLiF₄:Nd and calculations of the branching ratios determined by a Judd-Ofelt analysis (J. R. Ryan, R. Beach, J. Opt. Soc. Am. B 9, 1883 (1992), which is incorporated by reference for the corresponding discussion), implying a further correction of about 3. An actual measurement of the branching ratios obtained from the IR emission spectrum was performed by R. L. Cone at Montana State University using an Applied Detector Corp. 403L Ge detector at the exit slit of a Spex 1000M spectrometer. All spectra were referenced against a tungsten halogen lamp operating at 2800K. The measurement yielded a value of 31.1% for the fraction of the emission occurring to ⁴I_{9/2}, very close to the value calculated. This result produced a correction factor of 3.22±0.3. Finally, there is an uncertainty concerning the relative reflectivities of the samples and sodium salicylate reference. Although these may be somewhat different, they are probably both less than 20% in the strongly absorbing regions of the spectrum of interest. Thus, this should add not more than a ±10% error. Using an estimate that the absolute quantum yield of sodium salicylate as 0.58, implies an absolute quantum yield for the ⁴F_{3/2} emission of about 1.05±0.35. The estimated uncertainty is based on the accumulated errors discussed above. This value for the quantum yield is about three times the value of 0.32 (C. Feldmann, T. Justel, C. R. Ronda, D. U. Wiechert, J. Lumin. 92, 245 (2001), which is incorporated by reference for the corresponding discussion) obtained for GdLiF₄:Eu. However, it is still well below the theoretical maximum quantum yield of 2 based on the quantum splitting scheme described above. This highlights the fact that even in a system which exhibits highly efficient quantum splitting, other losses can limit the absolute quantum yield. Indeed, measurements of the quantum efficiency of the GdLiF₄:Eu quantum splitting phosphor (C. Feldmann, T. Justel, C. R. Ronda, D. U. Wiechert, J. Lumin. 92, 245 (2001), which is incorporated by reference for the corresponding discussion) show that a broad defect absorption reduces the quantum efficiency considerably. A study of the dynamics will allow for an examination of some of the reasons for the reduced quantum yield for GdLiF₄:Nd.

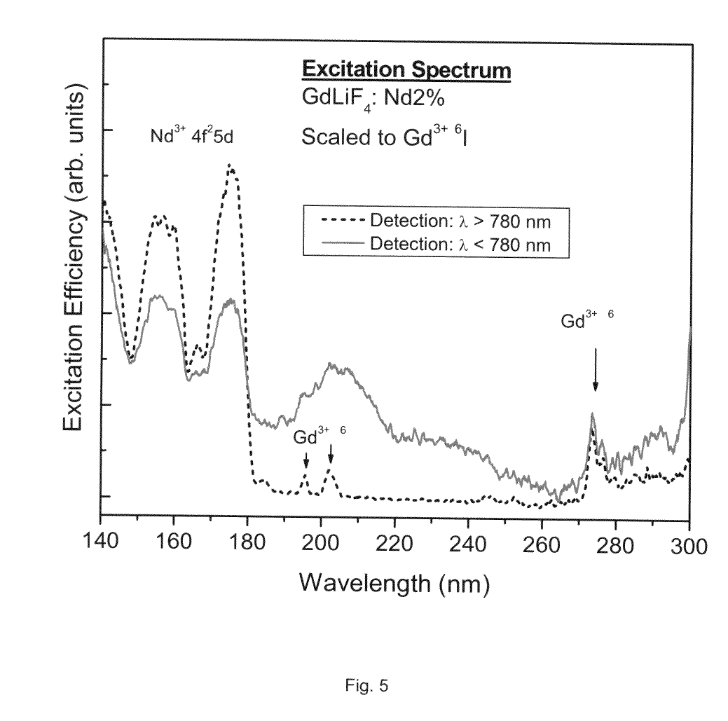

The excitation spectra for detection above and below 780 nm are compared in FIG. 5. The spectra are normalized to the Gd³⁺⁶I transition. The black (dotted) curve is obtained detecting wavelengths λ>780 nm so that only the Nd³⁺ IR emission from ⁴F_{3/2} is monitored. The red (solid) curve is the excitation spectrum for λ<780 nm and is dominated by Nd³⁺ emission from ⁴D_{3/2} which is not enhanced by the quantum splitting. Both the ⁶G excitation features of Gd³⁺ and the 4f²5d bands of Nd³⁺ are enhanced when detecting the ⁴F_{3/2} emission supporting the conclusion that quantum splitting plays an important role in the emission. For detection with λ<780 nm, there is evidence for an impurity or defect absorption band near 200 nm.

### Dynamics of the Quantum Splitting

Despite the fact that a great deal of work has been done on quantum splitting due to cross relaxation energy transfer (CRET), there have been, to our knowledge, only two studies (H. Kondo, T. Hirai, S. Hashimoto, J. Lumin. 108, 59 (2004); N Takeuchi, S. Ishida, A. Matsumura and Y Ishikawa, J. Phys. Chem B 108, 12397 (2004), which are incorporated by reference for the corresponding discussion) of the dynamics of this process. The studies considered the Gd³⁺—Eu³⁺ couple in GdNaF₄:Eu³⁺ and in GdLiF₄:Eu³⁺. Both the cross relaxation and direct transfer were observed with rates about two orders of magnitude slower than for the Gd³⁺—Nd³⁺ couple studied here. As pointed out in Wegh et al. (R. T. Wegh, H. Donker, K. D. Oskam, A. Meijerink, J. Lumin 82, 93 (1999), which is incorporated by reference for the corresponding discussion) the process achieves its efficiency because of energy migration among the Gd³⁺ ions which are stoichiometric in all known successful cross relaxation energy transfer quantum splitters. Dipole-dipole energy transfer or exchange is just too slow except for ions that are near neighbors. The fact that energy migrates within the Gd³⁺ ions ensures that the excitation in the ⁶G_{J} levels of Gd³⁺ gets to spend a portion of its time as a near neighbor of Nd³⁺. Thus, the dynamics within the Gd³⁺ system are expected to play an important role in the process.

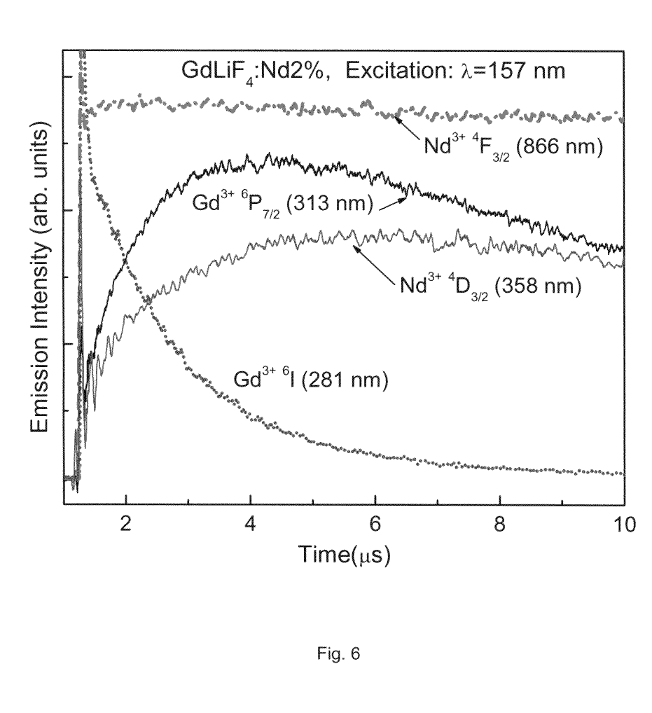

When a sample of GdLiF₄ containing 2% Nd³⁺ is excited at 157 nm with a molecular F₂ laser, one sees a buildup of the ⁶P_{7/2} transition of Gd³⁺ at 313 nm as shown in FIG. 6 by the black (dark solid) curve. This buildup has two components. One is very fast, at a rate which exceeds the time resolution of these experiments (<50 ns, limited by some background scattered light from the laser discharge and defect luminescence), which represents about 20% of the population feeding. The second is a slower buildup over several microseconds, representing about 80% of the feeding. The cause of these two components becomes clear from the dynamics of the ⁶I emission of Gd³⁺ at 281 nm shown by the purple (dotted) curve in FIG. 6. Its decay rate coincides with the ⁶P_{7/2} population buildup rate. Also shown in FIG. 6 by the red (dot-dashed) curve is the emission at 866 nm from the ⁴F_{3/2} state of Nd³⁺ which also builds up within the temporal resolution of the experiment. Thus, we conclude, as suggested based on an earlier discussion of the reduced matrix elements, that cross relaxation process B from FIG. 2 is the dominant one in the quantum splitting. However, the fact that the ⁶P_{7/2} population does have a very fast component indicates that there may also be a contribution from the cross relaxation energy transfer process labeled as A in FIG. 2. The relaxation of Gd³⁺ from ⁶I to ⁶P in a few microseconds is unlikely to occur due to multiphonon relaxation because of the large energy gap (˜3000 cm⁻¹) and low phonon energies of the GdLiF₄ host, but rather most likely occurs through the cross relaxation energy transfer process labeled C in FIG. 2. Consistent with this suggestion is the fact that the relaxation is dependent on Nd³⁺ concentration as discussed below. In this process a Nd³⁺ ion is excited from the ⁴I_{9/2} ground manifold to ⁴I_{13/2}, for which there is a good resonance match with the ⁶I→⁶P transitions on Gd³⁺.

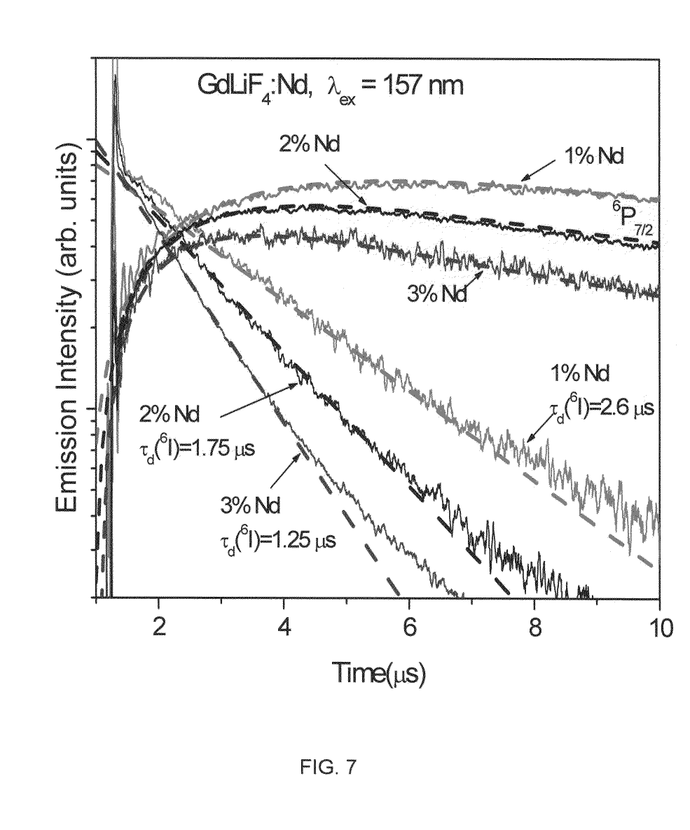

The behavior of the dynamics of process C and its concentration dependence provides important information on the role of donor-donor energy transfer among the Gd³⁺ ions. The dynamics of the ⁶I and ⁶P emissions are shown as a function of concentration in FIG. 7. The relaxation process is nearly exponential as seen by the dashed lines plotted over the ⁶I time-resolved emission, which are fits to the data assuming an exponential decay of ⁶I. The values for the fit are shown on the figure and are summarized in Table 1. The relaxation rate scales nearly linearly with concentration, as expected. Also shown are the time-resolved intensity of the ⁶P_{7/2} emission along with fits to the data using the ⁶I decay time as the feeding term in the ⁶P_{7/2} population. Indeed, the same times describe both the ⁶I and ⁶P_{7/2} emissions. The decay of ⁶P_{7/2} is also nearly exponential with a rate that depends on Nd³⁺ concentration. These rates are also summarized in Table 1. The nearly exponential relaxation processes for all three concentrations suggests that energy migration among the Gd³⁺ ions is fast compared to these CRET relaxation rates. In that case the Gd³⁺ excitation samples all sites thereby spending a fraction of its time nearby a Nd³⁺ ion with which it can undergo CRET. If, after energy transfer from the 4f²5d state of Nd³⁺ to Gd³⁺, the energy remained localized on that Gd³⁺ ion, the CRET rates would be highly non-exponential. In addition, without energy migration, CRET process C would be hindered, as all of the energy resonances that we have discussed assume that the Nd³⁺ ions are in their ground state. However, processes A and B leave the Nd³⁺ ion in an excited state for a time roughly equal to the lifetime of the ⁴F_{3/2} state of about 400 μs. Also, in the absence of rapid Gd³⁺—Gd³⁺ energy transfer, some of the possible processes providing the initial Nd³⁺—Gd³⁺ energy transfer could also leave Nd³⁺ in an excited state, as discussed earlier, compromising the CRET processes A and B which also assume that the Nd³⁺ ions are in their ground state.

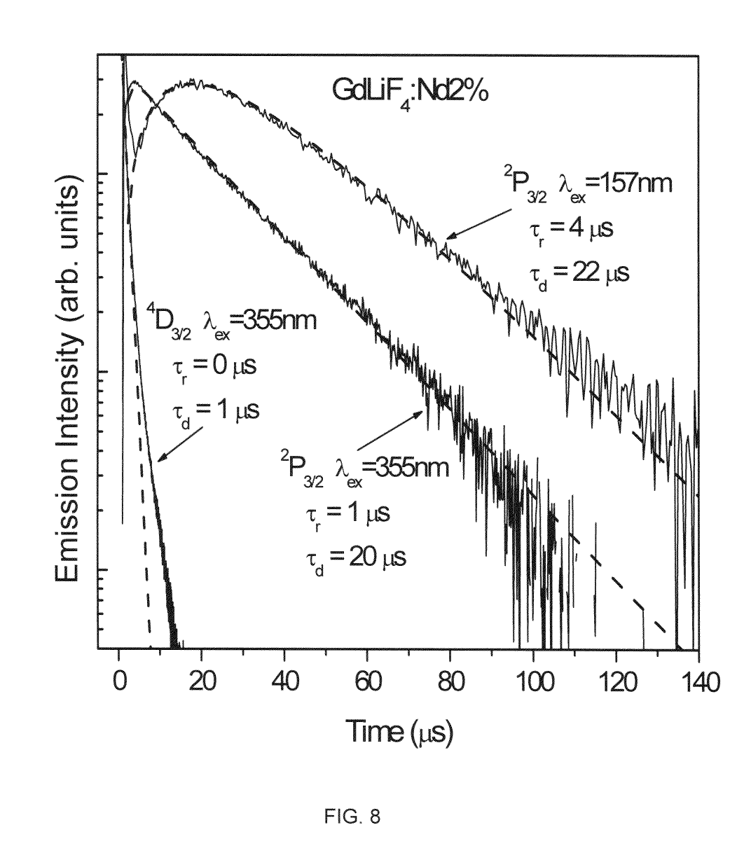

The excited Gd³⁺ ions in the ⁶P_{7/2} state then undergo energy transfer to the nearly resonant 4f³ states of Nd³⁺ at a rate described by the decay of the Gd³⁺⁶P_{7/2} emission. Proof of this second step is seen by monitoring the ⁴D_{3/2} emission under 157 nm excitation. It is observed that this emission closely follows the Gd³⁺⁶P_{7/2} population with a small delay, and that it has zero population immediately after the laser excitation (FIG. 6). This occurs because the intrinsic ⁴D_{3/2} lifetime (˜1 μs due to multiphonon relaxation to ²P^{3/2}) is much shorter than the ⁶P_{7/2} lifetime, as seen from its decay under direct 355 nm excitation into the 4f³ states just above ⁴D_{3/2}, as shown in FIG. 8. The fact that the ⁴D_{3/2} population closely follows the excited Gd³⁺ population demonstrates that energy transfer from Gd³⁺ to Nd³⁺ does occur, a process which is necessary for the second step of the quantum splitting process. The observation that the ⁴D_{3/2} emission (spectrally integrated) is more than an order of magnitude greater than the Gd³⁺⁶P_{7/2} emission (FIG. 1) indicates that a significant fraction of the Gd³⁺ ions transfer their energy to Nd³⁺ since the two populations follow one another because of the short inherent lifetime of ⁴D_{3/2}. Its greater time integrated intensity results from its faster radiative rate than that of ⁶P_{7/2} which is spin forbidden. Since we do not know the relative radiative rates, it is not possible to estimate from these relative intensities the efficiency of this Gd³⁺Nd³⁺ energy transfer.

The ⁴D_{3/2} state decays non-radiatively to ²P^{3/2} whose population dynamics are also shown in FIG. 8 for both 355 nm and 157 nm excitation. Under 355 nm excitation, it builds up at the ⁴D_{3/2} decay rate and decays in 20 μs, its intrinsic non-radiative lifetime. Under 157 nm excitation, it has a slower buildup resulting from the population feeding from ⁴D_{3/2} whose population is controlled by energy transfer from ⁶P_{7/2} of Gd³⁺. The ²P^{3/2} decay ultimately feeds ⁴F_{3/2} through multiphonon relaxation down the ladder of states of Nd³⁺ from whose radiative decay provides the second photon in the quantum splitting arises. Thus, the feeding of ⁴F_{3/2} for the second step in the quantum splitting continues for ˜100 μs.

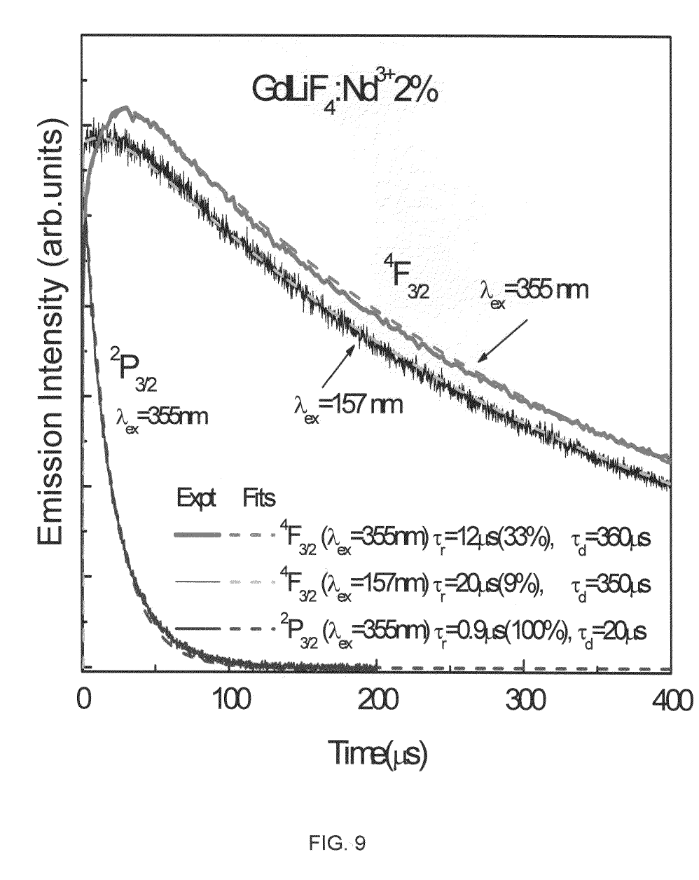

The temporal behavior of the ⁴F_{3/2} emission further supports the presence of quantum splitting. As shown in FIG. 9, when the 4f³ Nd³⁺ states just above ⁴D_{3/2} are excited directly at 355 nm, such that there is no quantum splitting, the ⁴F_{3/2} emission builds up with a rise time that is close to the value of the decay time of the ²P^{3/2} Nd³⁺ emission (20 μs). The ⁴F_{3/2} emission under 157 nm excitation, also shown in FIG. 9, shows a much more rapid buildup as expected due to the first step in the quantum splitting, namely the cross relaxation step. However, note that the ⁴F_{3/2} emission does not immediately begin an exponential decay. Rather its population remains high due to feeding from the second step in the quantum splitting, which maintains a feeding term for about ˜100 μs as ²P_{3/2} decays.

Attempts to fit the dynamics presented in FIG. 9 (dashed curves) with an exponential rise and decay indicate that under 355 nm excitation, the ⁴F_{3/2} emission has both a fast (immediate with respect to the experimental time resolution) followed by an exponential rise with a 12 μs rise time. The latter represents only 33% of the total contribution to the feeding of the ⁴F_{3/2} population. The source of the fast component is unknown, but it suggests the existence of some other channel of relaxation for 355 nm excitation. Under 157 nm excitation, there is again a fast component, resulting from the first CRET step due to processes A and B, followed by an additional feeding through ²P^{3/2} for about 100 μs (FIG. 8). Here, the additional feeding contributes only 9% to the ⁴F_{3/2} population. Under ideal conditions of quantum splitting, this should represent 50% of the contribution to the ⁴F_{3/2} population through the process labeled ET 2 in FIG. 2. Because of the observation that even under 355 nm excitation there exists an unexplained very fast component to the ⁴F_{3/2} population, it may be that a somewhat lower value than 50% should be expected. However, the fact that it is only 9% seems to explain, in part, the less than ideal quantum yield.

There are a number of potential sources for this reduced contribution including radiative transitions from ⁴D_{3/2} and ²P_{3/2} that are observed in FIG. 1, radiative transitions from ⁶P_{7/2} of Gd³⁺ prior to energy transfer to Nd³⁺, transfer of energy from ⁶P_{7/2} of Gd³⁺ to impurities or defects, and cross relaxation among Nd³⁺ ions. In addition, non-radiative processes involving ⁴F_{3/2} are possible. Indeed, the observed lifetimes of the ⁴F_{3/2} emission are below the low concentration limit of 535 μs in GdLiF₄:Nd and, in agreement with the results of Zhang et al. (X. X. Zhang, A. B. Villayerde, M. Bass, B. H. T. Chai, H. Weidner, R. I. Ramotar, R. E. Peale, J. Appl. Phys. 74, 790 (1993), which is incorporated by reference for the corresponding discussion), the 2% and 3% samples exhibit significant non-exponential behavior indicative of Nd³⁺—Nd³⁺ cross relaxation (not shown). However, while this would contribute to the reduced quantum yield, it would not explain the lower than expected contribution to the feeding of ⁴F_{3/2}.

### Discussion

It is of interest to examine the mechanisms for the cross relaxation energy transfer (CRET) responsible for the quantum splitting. For closely spaced ion pairs, this may occur by dipole-dipole interactions or exchange interactions (D. L. Dexter, Phys. Rev. 108, 630 (1957), which is incorporated by reference for the corresponding discussion). For more distant pairs, the exchange will become unimportant because of its rapid decrease with distance. According to Forster-Dexter dipole-dipole energy transfer theory, the transfer rate, P_{AB}^{dd} can be written (T. Kushida, J. Phys. Soc. Japan, 34, 1318 (1973), which is incorporated by reference for the corresponding discussion) as:

P_{AB}^{dd}=1.4×10²⁴f_{A}f_{B}S_{AB}ΔE⁻²R⁻⁶. (1)

Here f_{A} and f_{B}, are the oscillator strengths of the transitions on Nd³⁺ and Gd³⁺, ΔE is the transition energy of each ion (in eV), R is the distance between the two ions (in Angstroms), and, S_{AB} is the spectral overlap (in cm⁻¹) of the downward and upward transitions. In FIG. 3, it was shown for CRET process A that there are many ⁴I_{9/2}→⁴G_{5/2} transitions of Nd³⁺ that are nearly resonant with the ⁶G_{J}→⁶P_{J} transitions of Gd³⁺. The oscillator strength of each of these crystal field transitions of Nd³⁺ in YLiF₄ are typically (C. Gorller-Walrand, L. Fluyt, P. Porcher, A. A. S. Da Gama, G. F. de Sa, W. T. Carnall, G. L. Goodman, J. Less Common Metals 148, 339 (1989), which is incorporated by reference for the corresponding discussion) about ˜5×10⁻⁷ based on spectral analysis of some of the individual crystal field transitions at 20K. However, one can also estimate the oscillator strengths from experimental and calculated values integrated over all transitions in the manifolds by dividing by the number of final states which yields about the same average oscillator strength per crystal field transition (0. Guillot-Noel, B. Bellamy, V. Viana and D. Gourier, Phys. Rev. B60, 1668 (1999), which is incorporated by reference for the corresponding discussion). A similar situation holds for process B which involves the ⁶G_{J}>⁶I_{J} transitions of Gd³⁺ and the ⁴I_{9/2}→⁴F_{5/2}·²H_{9/2} or ⁴F_{7/2} transitions of Nd³⁺. These Nd³⁺ transitions also have oscillator strengths of about 5×10⁻⁷.

The oscillator strengths of the transitions within the ⁶G_{7/2}→⁶P_{J} or the ⁶G_{7/2}→⁶I_{J} manifolds of Gd³⁺ have not been measured, but their reduced matrix elements have been calculated (P. S. Peijzel, W. J. M. Schrama, A. Meijerink, Molec. Phys. S 102, 1285 (2004), which is incorporated by reference for the corresponding discussion). The reduced matrix elements for the ⁶G_{7/2}→⁶I_{J} transitions are almost a factor of 10 greater than those of the ⁶G_{7/2}→⁶P_{J} transitions, yielding the expectation that under similar resonance conditions, the probability for process B should be one to two orders of magnitude greater than for process A. As described earlier, a factor of 5 was observed. The difference may be due to the quality of the energy resonance for the two processes. The Gd³⁺ oscillator strengths are calculated based on the reduced matrix elements (P. S. Peijzel, W. J. M. Schrama, A. Meijerink, Molec. Phys. S 102, 1285 (2004), which is incorporated by reference for the corresponding discussion) for Gd³⁺ and Judd-Ofelt parameters for Gd³⁺ in YLiF₄ (A. Ellens, H. Andres, M. LT. Wegh, A. Meijerink, and G. Blasse, Phys. Rev. B 55, 180 (1997), which is incorporated by reference for the corresponding discussion). The total oscillator strength to all transitions ⁶G_{7/2}>⁶I is 2×10⁻⁶ and for ⁶G_{7/2}→⁶P_{7/2} it is 1.5×10⁻⁸. Since there are 39 final states in ⁶I, each crystal field transition, on average, has an oscillator strength of ˜5×10⁻⁸.

It is now possible to estimate the CRET transfer rates for dipole-dipole interactions in process B from Eq. (1). Using typical values of 3×10⁻⁷ for each transition of Nd³⁺ and 5×10⁻⁸ for each transition of Gd³⁺ and assuming a single perfect energy resonance with a linewidth at room temperature of 10 cm⁻¹ (spectral overlap integral=0.1) one finds a rate of ˜3.3×10⁵ s⁻¹ for a nearest neighbor pair separated by 3.73 A. This rate falls to ˜5×10⁴ S⁻¹ for a next nearest neighbor pair separated by 5.15 A. To predict what should be observed, one has to know whether the donor-donor transfer among the Gd³⁺ ions is occurring and whether it is faster than the donor-acceptor CRET rates. The results from the dynamics of process C involving a CRET from ⁶I to ⁶P suggest, based on the nearly exponential decay of ⁶I and rise of the ⁶P_{7/2} population, that the donor-donor transfer occurs much more rapidly than the observed CRET rate of ˜6×10⁵ s⁻¹ in the 2% Nd sample. If one assumes that the same is true for process A where the CRET rates are >2×10⁷ s⁻¹, then the predicted rates should take into account the fact that, on average, the excited Gd³⁺ excitation spends a fraction, 4x, (x is the fractional concentration of Nd³⁺) of its time as one of the four nearest neighbors of Nd³⁺. Thus for 2% Nd the nearest neighbor rate should be multiplied by a factor of 0.08, yielding a result of ˜2.7×10⁴ s⁻¹. This rate is obtained for one resonance between the Gd³⁺⁶G_{7/2}→⁶I and the ⁴I_{9/2}→⁴F_{5/2}·²H_{9/2} or ⁴F_{7/2} transitions of Nd³⁺. Even if one were to assume that all Nd³⁺ transitions were perfectly resonant with a transition on Gd³⁺, which would be an extreme assumption, and if contributions from more distant pairs are added, the maximum predicted rate still would be less than 10⁶ s⁻¹.

The assumption of rapid energy transfer among the Gd³⁺ donors is supported by studies of Gd³⁺—Gd³⁺ interactions. Studies of band-to-band exciton transitions in GdCl₃, Gd(OH)₃, and Tb(OH)₃ have shown that exchange interactions among nearest neighbor ions can yield resonant energy transfer rates among nearest neighbors that are as large as 10¹⁰ to 10¹¹ s⁻¹ for resonant energy transfer among Gd³⁺ ions in their ⁶P_{7/2} state or Tb³⁺ ions in their ⁵D₄ state (R. L. Cone and R. S. Meltzer, Phys. Rev. Letts. 30, 859 (1973) and R. L. Cone and R. S. Meltzer, J. Chem. Phys. 62, 3573 (1975), which is incorporated by reference for the corresponding discussion). These rates correspond to the condition of resonance with homogeneous linewidths at 1.5 K of about 0.1 cm⁻¹. At room temperature, where these linewidths are ˜10 cm⁻¹, corresponding rates would be 10⁸ to 10⁹ s⁻¹. Even though the exchange interaction will probably be considerably smaller in fluorides, the expectation that donor-donor transfer rates for the ⁶G state of Gd³⁺ should exceed 2×10⁷ s⁻¹ in GdLiF₄ seems quite reasonable.

In the limit of no energy transfer among the Gd³⁺ ions then the relaxation after the initial energy transfer from Nd³⁺→Gd³⁺ would occur by interactions between a pair of nearest neighbors. This rate would have a maximum value of ˜5×10⁶ s⁻¹ if all transitions of the two ions were resonant. Even this extreme assumption falls well short of explaining the observed rate of >2×10⁷ s⁻¹ and the absence of fast donor-donor transfer seems unlikely. Thus the above analysis of the experiments points strongly to the dominant role of exchange interactions in facilitating the CRET responsible for quantum splitting in GdLiF₄:Nd.

TABLE 1
Experimental energy transfer rates.

| | Nd³⁺ | | | Expt ET |
|---|---|---|---|---|
| Process | conc. | Gd³⁺ | Nd³⁺ | rate (s⁻¹) |
| CRET A | All | ⁶G → ⁶P | ⁴I_{9/2} → ⁴G_{5/2} | >2 × 10⁷ |
| CRET B | All | ⁶G → ⁶I | ⁴I_{9/2} → ⁴F_{5/2}, ²H_{9/2} | >2 × 10⁷ |
| CRET C | | ⁶I → ⁶P | ⁴I_{9/2} → ⁴I_{13/2} | |
| | 1% | | | 3.8 × 10⁵ |
| | 2% | | | 5.7 × 10⁵ |
| | 3% | | | 8.0 × 10⁵ |
| Gd³⁺ → Nd³⁺ | | ⁶P_{7/2} → ⁸S_{7/2} | ⁴I_{9/2} → ²L_{17/2} | |
| | 1% | | | 4.3 × 10⁴ |
| | 2% | | | 6.7 × 10⁴ |
| | 3% | | | 9.1 × 10⁴ |

### CONCLUSIONS

Efficient quantum splitting has been demonstrated for the Gd³⁺—Nd³⁺ system in GdLiF₄:Nd 2%. A VUV photon is absorbed by the Nd³⁺ ions whereupon the energy is rapidly transferred to the high-lying excited states of the 4f⁷ configuration of Gd³⁺ in a time scale of nanoseconds. A rapid and effective cross relaxation energy transfer then occurs in two steps. In the first, a Gd³⁺ ion in its metastable ⁶G state undergoes a transition to ⁶I while Nd³⁺ ions makes a transition ⁴I_{9/2}→⁴F_{5/2}, ²H_{9/2} or ⁴F₇/at a rate>2×10⁷ s⁻¹. Multiphonon relaxation effectively brings the Nd³⁺ ions down to the ⁴F₃/state where they radiate the first photon. For the remaining excited Gd³⁺ ion, there occurs a second cross relaxation energy transfer in which Gd³⁺ undergoes a transition ⁶I→⁶P and Nd³⁺ is excited from ⁴I_{9/2}→⁴I_{13/2}. The resulting ⁶P_{7/2} excitation on Gd³⁺ transfers its energy to nearly resonant states of the 4f³ configuration of Nd³⁺ in a time scale of about 10-20 μs, whereby subsequent relaxation brings the population down to ⁴F_{3/2} of Nd³⁺ where the second photon is emitted. This second step appears to be less efficient than the first. The result is a quantum yield for the emission of IR photons which has its maximum of about 1±0.5, under 175 nm excitation. This is considerably below the theoretical value of 2. Nonetheless, this system exhibits the highest quantum yield for quantum splitting based on cross relaxation energy transfer and provides excellent insights into the quantum splitting process, especially with regard to an evaluation of the details of the dynamics and the mechanisms of quantum splitting. An analysis of the dynamics and the theoretical limits of the dipole-dipole contributions, leads to the conclusions that (1) there is rapid donor-donor energy migration among the Gd³⁺ ions and (2) that exchange plays the dominant role in the cross relaxation energy transfer responsible for the quantum splitting.

### Example 2

Nd³⁺-sensitized quantum splitting for the Gd³⁺—Nd³⁺ couple is studied in mixed GdₓY₁₋ₓLiF₄:Nd phosphors as a function of the Gd³⁺ concentration. Quantum splitting is observed for all samples studied which include the concentration range 0.1<x<1. After excitation of the 4f²5d state of Nd³⁺, rapid energy transfer occurs to Gd³⁺, as evidenced by the decrease of 4f²5d emission with increasing x. The quantum splitting involves a cross relaxation in which the ⁶G state of Gd³⁺ undergoes a downward transition to its lower lying 4f⁷ levels with the simultaneous transition of Nd³⁺ from its ground state to an excited state in the 4f³ configuration that is resonant with the Gd³⁺ downward transition. The dynamics are strongly affected by x. For x<0.25, the buildup of the ⁶P emission of Gd³⁺ has two distinct components with very different time scales, microseconds and milliseconds. The rate of the fast component increases with a reduction in x. This points to the role of energy migration among Gd³⁺. The slower time scale is similar to that of isolated Gd³⁺ ions. The existence of these two very distinct temporal regimes points to the importance of exchange, which is a very short range interaction, in the quantum cutting process.

### Introduction

We have described quantum splitting in a new system, the Gd—Nd pair in GdLiF₄:Nd which exhibits measured quantum yields of 1.05±0.35 (W. Jia, Y. Zhou, S. P. Feofilov, R. S. Meltzer, J. Y. Jeong and D. Keszler, Phys. Rev. B, in press (2005), which is incorporated by reference for the corresponding discussion). While the photons in this case are in the infrared, and are therefore not useful for a visible phosphor, the system provides a prototype with which to study the dynamics of the CRET quantum splitting process. This process seems to depend strongly on rapid energy migration among the Gd³⁺ ions and the presence of very closely coupled pairs. In order to test these assumptions and to gain a further insight into the mechanism of the CRET process, the emission and excitation spectra, along with the dynamics of the emission, as a function of Gd³⁺ concentration are studied in the mixed crystal system GdₓY₁₋ₓF₄:Nd.

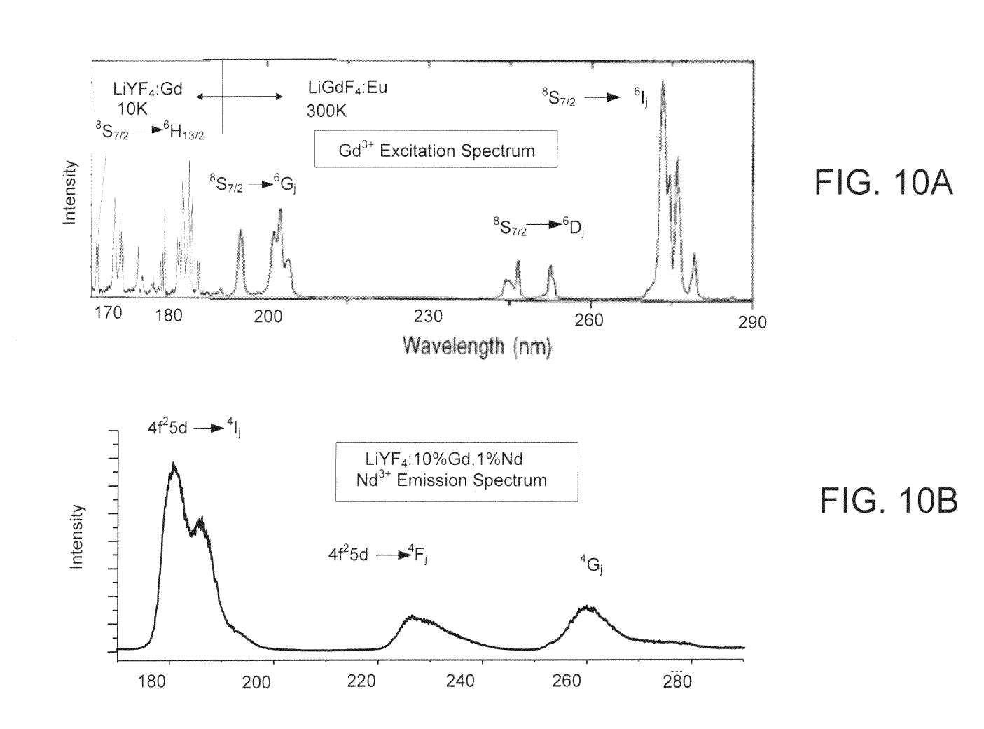

For the Gd—Nd pair in GdLiF₄:Nd, absorption takes place on Nd³⁺ into the 4f²5d state in the VUV, as shown by the bold vertical arrow in FIG. 2. The first step in the quantum splitting requires an energy transfer to Gd³⁺ shown by the arrow labeled ET1. While there are a number of possible paths for this energy transfer which could leave the Gd³⁺ ions in any of its sextet excited levels, a comparison of the emission spectrum of Nd³⁺ from its 4f²5d configuration with the excitation spectrum of Gd³⁺ shows that the most favorable overlap of these spectra occurs for the Gd³⁺ transitions above the ⁶G_{J} levels at about 55,000 cm⁻¹, as shown in FIG. 10. The excitation spectra in FIG. 10 are constructed from that of YLiF₄:5% Gd at 10K (monitoring the Gd emission) for wavelengths below 200 nm (R. T. Wegh, H. Donker, A. Meijerink, R. J. Lamminmaki, J. Holsa, Phys. Rev. 56, 13841 (1997), which is incorporated by reference for the corresponding discussion) and from GdLiF₄:2% Eu (monitoring the Eu emission) at 300K for wavelengths above 200 nm (R. T. Wegh, H. Donker, K. D. Oskam, A. Meijerink, J. Lumin 82, 93 (1999), which is incorporated by reference for the corresponding discussion). The emission spectrum is from Gd_{0.1}Y_{0.9}LiF₄:1% Nd at 300K. The spectra of GdLiF₄ and YLiF₄ doped with rare earth ions are almost identical so this comparison is well justified (F. G. Anderson, H. Weidner, P. L. Summers, R. E. Peale, J. Lumin. 62, 77 (1994), which is incorporated by reference for the corresponding discussion). Rapid non-radiative relaxation among the closely spaced levels above ⁶G populates this metastable level. The second step in the quantum splitting involves a CRET in which the ⁶G level of Gd³⁺ undergoes a transition to one of its lower-lying excited states while a Nd³⁺ ion is excited from its ground state, indicated by CRET processes A and B in FIG. 2. As shown previously, the dominant pathway involves CRET B whereby Gd³⁺ undergoes a transition to ⁶G→⁶I and Nd³⁺ undergoes a transition from its ground state to ⁴F_{5/2}. Rapid non-radiative relaxation within Nd³⁺, resulting from the high density of closely spaced levels which are shown by the box with closely spaced horizontal lines, populates the metastable ⁴F_{3/2} level from which the first photon of the quantum splitting is emitted. The third step involves a second CRET process in which Gd³⁺ undergoes a transition from ⁶I to ⁶P while Nd³⁺ receives the energy difference. There are a number of possible pathways which will be discussed below. In the fourth step the excited Gd³⁺ ion in the ⁶P_{7/2} level then transfers its energy nearly resonantly to Nd³⁺. Relaxation within Nd³⁺, first to the ⁴D_{3/2} and then the ²P^{3/2} metastable states, followed by multiphonon emission, populates the ⁴F_{3/2} state leading to the emission of the second photon. While these processes remain similar for the mixed crystals, there are significant differences which reveal important information about the quantum splitting processes.

### Methods

Samples of GdₓY₁₋ₓLiF₄:Nd containing 2 mol % Nd were prepared in powder form as described previously (W. Jia, Y. Zhou, S. P. Feofilov, R. S. Meltzer, J. Y. Jeong and D. Keszler, Phys. Rev. B, in press (2005), which is incorporated by reference for the corresponding discussion). All spectra were obtained at room temperature. Emission spectra were obtained by exciting the sample, contained in vacuum, either with a D₂ lamp, spectrally selected with a VUV monochromator or with an excimer laser operating at 157 nm (molecular F₂ laser). The detection scheme has been described previously (W. Jia, Y. Zhou, S. P. Feofilov, R. S. Meltzer, J. Y. Jeong and D. Keszler, Phys. Rev. B, in press (2005), which is incorporated by reference for the corresponding discussion). All emission spectra were corrected for the wavelength dependent response of the detection system.

### Results

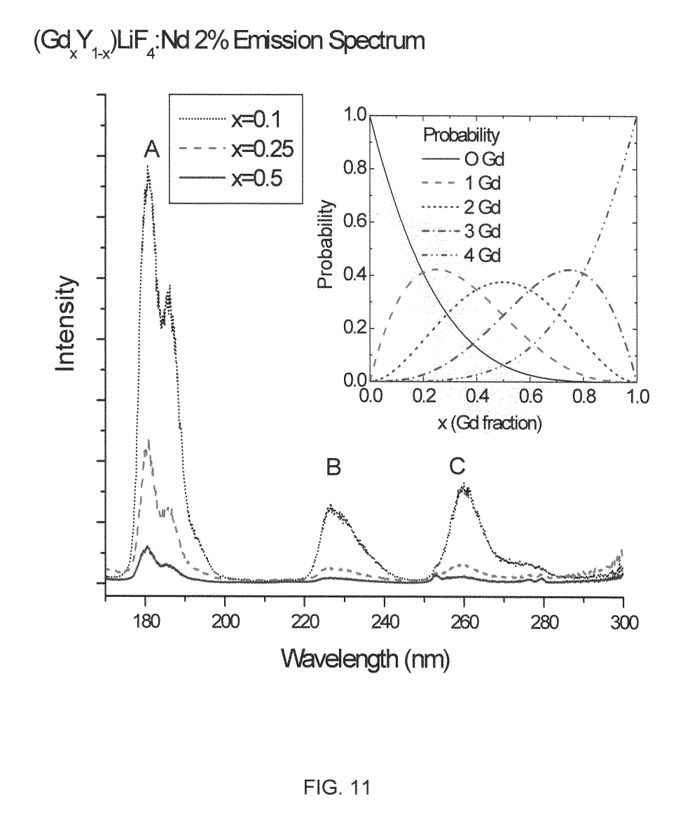

When the 4f²5d configuration of Nd³⁺ in YLiF₄:Nd is excited, strong parity allowed emission is observed in the VUV and UV (P. W. Dooley, J. Thogersen, J. D. Gill, H. K. Haugen, R. L. Brooks, Opt. Commun. 183, 451 (2000), which is incorporated by reference for the corresponding discussion). This 4f²5d emission, excited at 157 nm with a molecular F₂ laser, is also observed in GdₓY₁₋ₓF₄:Nd for x<0.5 as shown in FIG. 11. However, as the Gd³⁺ concentration is increased, the 5d emission rapidly decreases. No 5d emission is observed in pure GdLiF₄:Nd. The intensity as a function of concentration is compared with the probability of finding a Nd³⁺ ion with no Gd³⁺ ions in the nearest neighbor (nn) position in the insert of FIG. 11 (solid curve). In GdLiF₄ the Nd substitutes for Gd. Each Gd has four equivalent nearest neighbors at a distance of 3.73 Å. The next nearest neighbors consist of four equivalent ions at 5.17 Å. The probability of finding a Nd³⁺ ion with only Y³⁺ ions is (1−x)⁴. A comparison of the concentration dependence of the ratio of 5d emission intensity, with this probability shows that it roughly follows this probability for each of the three main bands of FIG. 11. This suggests that the energy transfer occurs effectively to Gd³⁺ ions in the nearest neighbor position, but not efficiently to the next nearest neighbors. The radiative lifetime of the 4f²5d state of Nd³⁺ in YLiF₄ is 35 ns (A. F. H. Librantz, L. Gomes, L. V. G Tarelho, I. M. Ranieri. J. Appl. Phys. 95, 1681 (2004), which is incorporated by reference for the corresponding discussion). Thus, nearest neighbor energy transfer occurs at a rate>10⁸ s⁻¹ whereas the rate of transfer to the second nearest neighbors is much slower. These results indicate that Nd³⁺ does effectively sensitize Gd³⁺ when excited in the VUV.

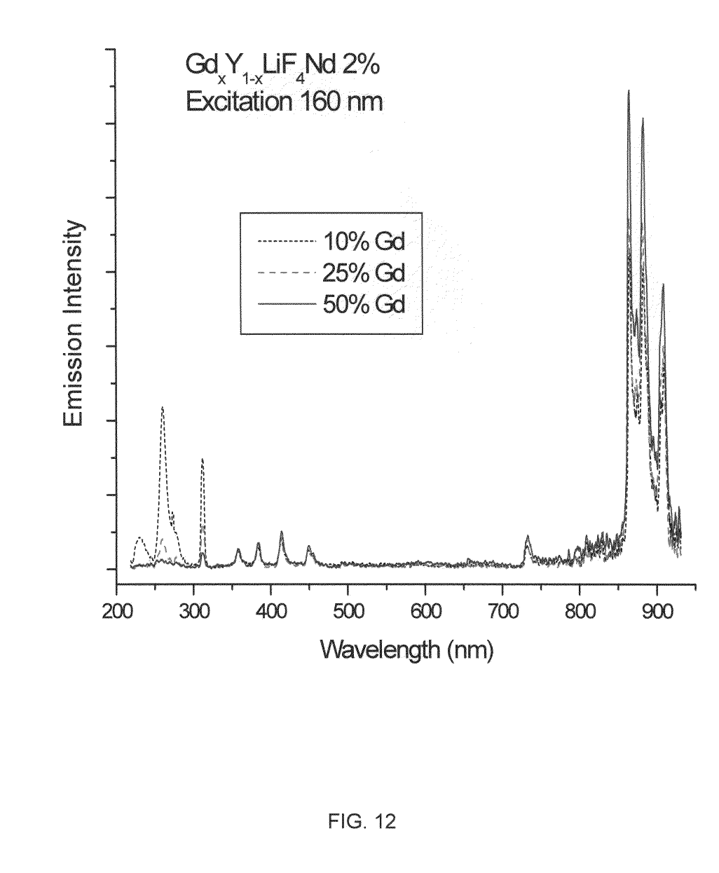

The emission spectrum from 220 nm to 930 nm, excited at 160 nm, is presented in FIG. 12. Three changes are noticed as the Gd³⁺ concentration increases: (1) the 4f²5d emission decreases as discussed previously, (2) the time integrated emission from the ⁶P_{7/2} state of Gd³⁺, seen at 313 nm, decreases, and (3) the ⁴F_{3/2} emission in the IR becomes relatively enhanced. Thus, the presence of Gd³⁺ promotes the conversion of energy initially excited to the 4f²5d configuration into ⁴F_{3/2} emission. After the initial CRET process B in which the Gd³⁺ ion undergoes a transition first from its ⁶G_{J} to ⁶I_{J} followed by a second CRET C leaving it in ⁶P_{7/2}, efficient energy transfer back to Nd³⁺, in the step described as ET2 in FIG. 2, occurs more rapidly with an increase in Gd³⁺ concentration. This occurs because the excitation can move more effectively on the Gd³⁺ sublattice, thereby more easily finding a nearest neighbor Nd³⁺ ion with which to transfer its energy. As discussed below, the reason for the decrease in time-integrated ⁶P emission with Gd³⁺ concentration is more complicated than might at first appear. The enhancement of the Nd³⁺⁴F_{3/2} luminescence supports the assertion that quantum splitting occurs. CRET with Gd³⁺ provides an additional channel for the population of this state in addition to population feeding from relaxation directly within a single Nd³⁺ ion. It should also be recognized that in the more dilute Gd³⁺ samples where 4f²5d emission is observed, cascade emission can also contribute to the rapid population of ⁴F_{3/2}. All 4f²5d emission at wavelengths longer than 220 nm (FIG. 10) populate either ⁴F_{3/2} or states above it which relax quickly to ⁴F_{3/2}. Since this process diminishes as the Gd³⁺ concentration is increased, the increase of ⁴F_{3/2} emission points even more strongly to some additional feeding which we assign to the CRET with Gd³⁺.

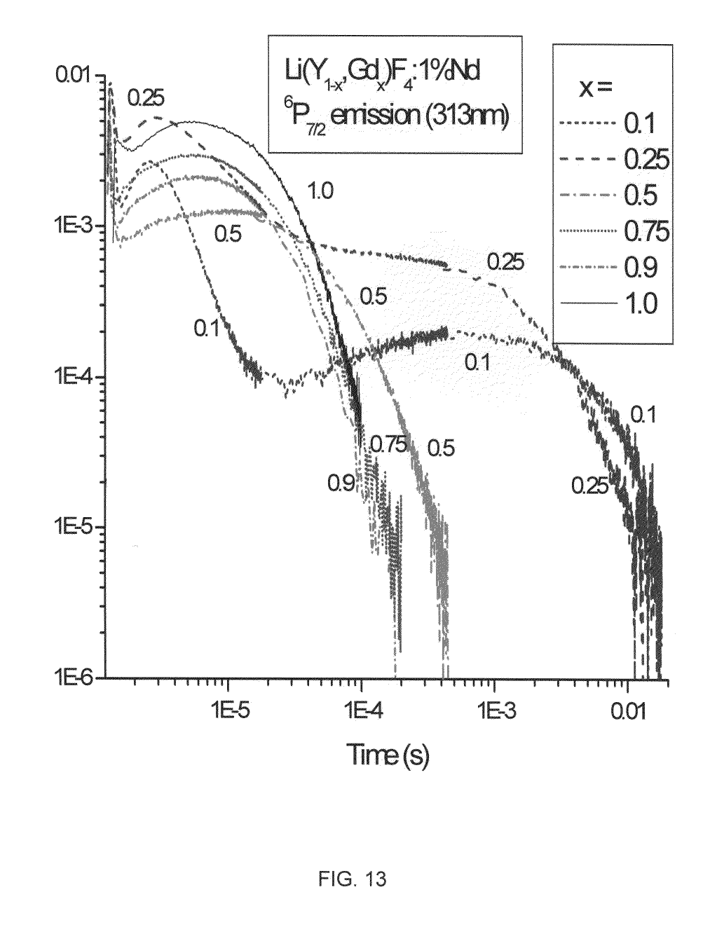

The dynamics provide a great insight into the mechanism for the CRET. Plotted in FIG. 13 are the dynamics of the ⁶P_{7/2} emission of Gd³⁺ in the samples with different Gd³⁺ concentrations at a constant 2% concentration of Nd³⁺. The data are plotted as a log-log plot to allow the presentation of data over a wide range in both time and intensity. The data for each concentration were obtained by combining the results obtained with different time scales and different input impedances on the digital oscilloscope in order to cover the large time scales while still providing adequate resolution at early times. All samples with x>0.5 show nearly identical behavior. The dynamics for these high Gd³⁺ concentrations show (1) a very fast (<20 ns) rise in population, (2) a fast but slower additional rise during the first 10 μs, and (3) then a nearly exponential decay with decay time of about 100 μs. The population buildup is much faster than would be expected from non-radiative decay from the high-lying levels of Gd³⁺ based on multi-phonon emission. We attribute it to CRET processes with Nd³⁺. For x>0.5 energy transfer to Gd³⁺ occurs rapidly as evidenced by the absence of 4f²5d emission from Nd³⁺. As described above, spectral overlap favors transfer to the states of Gd³⁺ resonant with the 4f²5d states of Nd³⁺ followed by multi-phonon relaxation to the metastable ⁶G_{J} levels. Based on previous work in x=1 samples, the fast rise involves a CRET labeled A in FIG. 2, while the slower component of the rise in ⁶P_{7/2} population results from feeding from ⁶I according to a sequential energy transfer involving CRET processes B and C in FIG. 2. As shown by Wegh et al. (P. S. Peijzel, W. J. M. Schrama, A. Meijerink, Molec. Phys. S 102, 1285 (2004), which is incorporated by reference for the corresponding discussion), process B actually has the larger Gd³⁺ transition dipole reduced matrix elements.

The dynamics for the samples with x<0.5 are quite different as also seen in FIG. 13. For the x=0.1 sample, the ⁶P_{7/2} population exhibits two distinct regimes. In the first temporal regime, one sees that, as for the samples with high concentrations, there exist a (1) fast (<30 ns) and (2) slower (˜2 μs) rise, followed by (3) a decay (˜10 μs). The dynamics in this first regime occur considerably faster than that of the high Gd³⁺ content samples. In the second temporal regime the ⁶P_{7/2} population slowly builds up (−1 ms) again before decaying (˜10 ms). The decay rate in this second regime is very close to that observed for a sample with 2% Gd³⁺ and no Nd³⁺. This striking and unusual behavior points to the existence of two very different classes of Gd³⁺—Nd³⁺ arrangements. Those responsible for the dynamics exhibited in the first time regime probably involve Nd³⁺ ions with at least one Gd³⁺ ion in a nearest neighbor position to which it couples strongly. For x=0.1, this represents about 38% of the Nd³⁺ ions. The ions responsible for the dynamics in the second temporal regime must be Gd³⁺ ions which couple very weakly with the Nd³⁺ ions since their decay from the ⁶P_{7/2} level is nearly identical to that of isolated Gd³⁺ ions. Their population buildup would then result from relaxation from the higher lying states of Gd³⁺. It is likely that they are excited by a direct excitation of Gd³⁺ to the states of the 4f⁷ configuration at the 157 nm laser excitation wavelength. Note that the peak emission intensity is only about 5% that of the first group of ions as a result of their much weaker parity forbidden absorption.

The sample with x=0.25 exhibits a dynamical behavior similar to that of the x=0.1 sample except that a minimum in the emission rate is not observed. This can be understood by the fact that the increased Gd³⁺ content makes direct excitation 2.5 times more probable, representing a higher fraction of the Gd³⁺. Although the percentage of Nd³⁺ ions with at least one nearest neighbor Gd³⁺ ion also increases to about 70%, the dynamics of the first regime is slower, causing the two regimes to merge so that a minimum in the population is not observed. Nonetheless, two regimes are still clearly discernible.

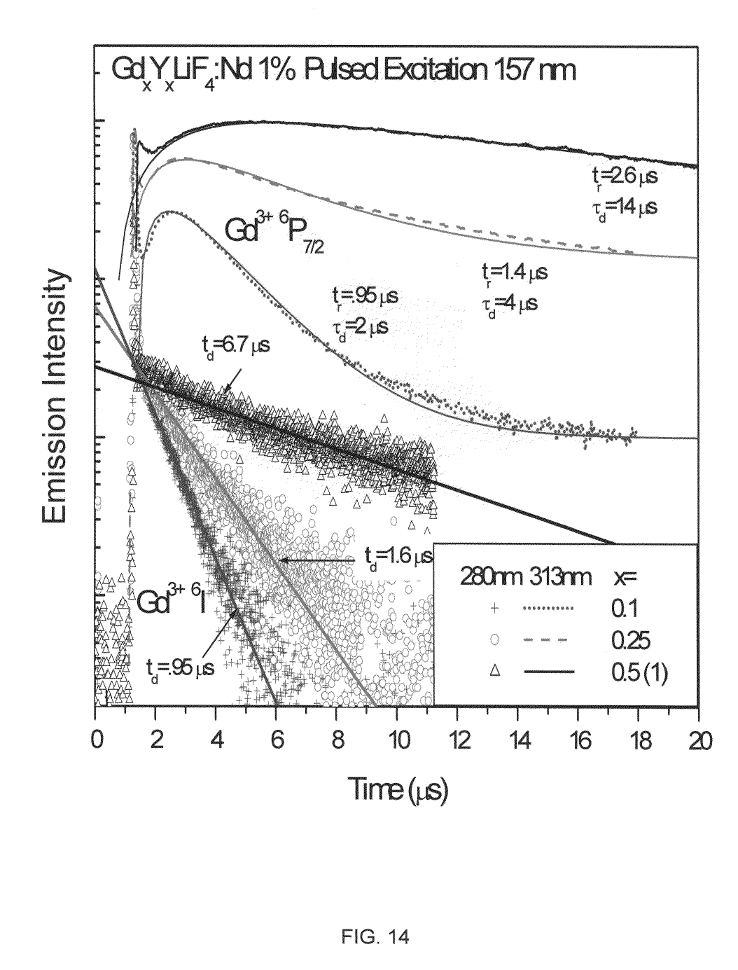

The Gd³⁺ concentration dependence of the dynamics in the first (short) time regime is examined in more detail in FIG. 14 where the emission of both ⁶P_{7/2} and ⁶I are plotted together on a semilog plot. One sees that for each Gd³⁺ concentration the decay time obtained from fits to the dynamics of the ⁶I emission is nearly identical to the rise time of the ⁶P_{7/2} emission. The decay rates of the dynamics in the short time regime increase as the Gd³⁺ concentration decreases. This is true both for the CRET process C in FIG. 2 which feeds ⁶P from ⁶I and for the energy transfer process ET2 that returns the energy to Nd³⁺ for the second step in the quantum splitting. This may seem contradictory to the increase in the time-integrated ⁶P_{7/2} emission intensity with a decrease in Gd³⁺ concentration, but this is caused by the weaker, but very long-lived emission from the nearly isolated Gd³⁺ ions.

It is striking and counter intuitive that the dynamics in the first time regime is faster for the x=0.1 sample than for the sample with x=1. This observation suggests that the dynamics within the Gd³⁺ ions plays a significant role. For samples with x=1, rapid resonant energy transfer allows the excitation to move away from the Nd³⁺ ion from which it received its energy so that it spends only a fraction of its lifetime as a nearest neighbor to Nd³⁺. As a result, the probability of CRET processes A, B and C and the energy transfer in the step labeled ET2 in FIG. 2 are reduced in the samples with higher Gd³⁺ concentrations. For the x=0.1 sample, the majority of the Gd³⁺ ions coupled as nearest neighbors to Nd³⁺ (−73%) do not have a nearest neighbor (nn) Gd³⁺ to which it can transfer energy. As a result the energy remains localized near the Nd³⁺ ion from which it received its energy, leading to these faster energy transfer rates. For CRET process C, in which the Gd³⁺ ions undergo a transition ⁶I→⁶P, the nn Nd³⁺ ion is in its ⁴F_{3/2} excited state after rapid multiphonon relaxation from the ⁴F_{5/2} state created in the first step of the quantum splitting (CRET process B). The second CRET step, process C, therefore takes the nn Nd³⁺ from ⁴F_{3/2} to ⁴F_{9/2} which is nearly resonant with the ⁶I→⁶P_{5/2} transition of Gd³⁺.

The existence of these two distinct group of ions, those which are strongly coupled to Nd³⁺, and those that are only very weakly (essentially uncoupled) points to the dominant role of exchange in governing the energy transfer processes. Based on the crystal structure of GdLiF₄ (like YLiF₄) each Gd³⁺ (or Nd³⁺) has four nearest neighbor trivalent cations at a distance of 3.73 Å. The nearest neighbors in the next shell consist of two groups of four ions at about 5.17 Å. Dipole-dipole interactions fall off as R⁻⁶. Based only on geometric considerations, the ratio of energy transfer rates for the case of nearest versus next nearest neighbor positions for the ion pair would be about 4. This distinction would be incapable of producing two such distinct groups of ions. Including the third and fourth shell, such that essentially all Gd³⁺ ions are accounted for, does not significantly alter this fact since the distances of these next shells do not increase very rapidly. On the other hand, exchange (here likely superexchange) interactions fall exponentially with distance such that they are likely negligible for the case of next nearest neighbors. Thus Gd³⁺ ions with no Nd³⁺ ions in the nearest neighbor positions, behave like isolated uncoupled ions. Ions which exist as pairs in the nearest neighbor position are strongly coupled producing rapid energy transfer.

There remains one issue that is especially relevant for the x=0.1 sample. For Nd³⁺—Gd³⁺ pairs that are isolated, in the sense that there are no Gd³⁺ ions in the other three nearest neighbor positions to the Gd³⁺, the Gd³⁺ excitation energy would need to undergo energy back transfer to the Nd³⁺ from which it originally received its energy in order to complete the last step in the quantum splitting. However, after the CRET which leaves the Gd³⁺ ion in the ⁶P_{7/2} state, the Nd³⁺ ion is left in its ⁴F_{3/2} state, not the ground state. Energy conservation regarding an energy transfer from Gd³⁺ in its ⁶P_{7/2} state would require exciting the Nd³⁺ from its ⁴F_{3/2} state to a state at about 44,000 cm⁻¹ where there are no such expected levels. However, it is clear by monitoring the emission of the highest-lying metastable state of Nd³⁺, ⁴D_{3/2} at 28,000 cm⁻¹, that energy transfer from ⁶P_{7/2} of Gd³⁺ to Nd³⁺ does take place for the ions involved in the fast time regime. Such a problem does not exist for x>0.5 since rapid energy migration allows the energy to move to a Gd³⁺ ion nearby a different Nd³⁺ ion which is in its ground state.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified. In addition, the phrase “about ‘x’ to ‘y’” includes “about ‘x’ to about ‘y’”.

It should be emphasized that the above-described embodiments of the present disclosure, particularly, any “preferred” embodiments, are merely possible examples of implementations, and are merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

Therefore, at least the following is claimed:

1. A composition, comprising:
GdₓY₁₋ₓLiF₄:Nd, wherein 0.1≦x<1.

2. The composition of claim 1, wherein 0.1<x<1.

3. The composition of claim 1, wherein Nd³⁺ is about 0.5 to 3 mol % of the composition.

4. The composition of claim 1, wherein the Nd³⁺ is about 1 to 3 mol % of the composition.

5. The composition of claim 1, wherein the Nd³⁺ is about 2 mol % of the composition.

6. The composition of claim 1, wherein the composition exhibits measured quantum yields of about 0.70 to 1.40.

7. The composition of claim 1, wherein x is about 0.5.

8. The composition of claim 1, wherein x is about 0.25.

9. The composition of claim 1, wherein x is about 0.1.

10. The composition of claim 1, wherein Nd³⁺ is replaced by Tm³⁺.

11. A method of making GdₓY₁₋ₓLiF₄:Nd (0.1≦x<1) comprising:
synthesizing Gd₁₋ₓYₓF₃ by heating a mixture of molar equivalents of the following: about 1−x Gd₂O₃, about x Y₂O₃, and about 3 to 8 NH₄F at about 750 to 950° C. for about 1 to 4 h;
mixing the Gd₁₋ₓYₓF₃ with molar equivalents of the following: about 1 to 1.25 LiF, about 0.005 to 0.05 Nd₂O₃, and about 2 to 5 NH₄F;
thoroughly grinding the mixture; and
firing the mixture at about 650 to 850° C. for about 1 to 4 h.

12. The method of claim 11, further comprising:
firing the mixture in a Pt crucible, wherein the Pt crucible is covered and positioned inside an alumina crucible filled with activated carbon and NH₄F to limit the exposure of the sample to air.

13. The method of claim 11, further comprising:
synthesizing Gd₁₋ₓYₓF₃ by heating a mixture of molar equivalents of the following: about 0.1 to 1 Gd₂O₃, about >0 to 0.9 Y₂O₃, and about 3 to 8 NH₄F at about 750 to 950° C. for about 1 to 4 h.

14. The method of claim 11, further comprising:
synthesizing Gd₁₋ₓYₓF₃ by heating a mixture of molar equivalents of the following: about 1−x Gd₂O₃, about x Y₂O₃, and about 8 NH₄F at about 900° C. for about 1.5 h.

15. The method of claim 11, further comprising:
mixing the Gd₁₋ₓYₓF₃ with molar equivalents of the following: about 1.15 LiF, about 0.01 to 0.03 Nd₂O₃, and about 4 NH₄F.

16. The method of claim 11, further comprising:
firing the mixture at about 750° C. for about 1.5 h in a Pt crucible, wherein the Pt crucible is covered and positioned inside an alumina crucible filled with activated carbon and NH₄F to limit the exposure of the sample to air.

17. A method of making GdₓY₁₋ₓLiF₄:Nd (0.1<x<1) comprising:
synthesizing Gd₁₋ₓYₓF₃ by heating a mixture of molar equivalents of the following: about 1−x Gd₂O₃, about x Y₂O₃, and about 3 to 8 NH₄F at about 750 to 950° C. for about 1 to 4 h;
mixing the Gd₁₋ₓYₓF₃ with molar equivalents of the following: about 1 to 1.25 LiF, about 0.005 to 0.05 Nd₂O₃, and about 2 to 5 NH₄F;
thoroughly grinding the mixture; and
firing the mixture at about 650 to 850° C. for about 1 to 4 h.

18. The method of claim 17, further comprising:
firing the mixture in a Pt crucible, wherein the Pt crucible is covered and positioned inside an alumina crucible filled with activated carbon and NH₄F to limit the exposure of the sample to air.
